(19) United States
(12) Patent Application Publication
(10) Pub. No.: US 2019/0277139 A1
(43) Pub. Date: Sep. 12, 2019

(54) STEAM TURBINE APPARATUS

(71) Applicant: MITSUBISHI HEAVY INDUSTRIES, LTD., Tokyo (JP)

(72) Inventors: Kazuyuki MATSUMOTO, Tokyo (JP); Yoshihiro KUWAMURA, Tokyo (JP); Hideaki SUGISHITA, Tokyo (JP); Toyoharu NISHIKAWA, Tokyo (JP); Kei NAKANISHI, Tokyo (JP); Makoto KONDO, Tokyo (JP)

(21) Appl. No.: 16/289,978

(22) Filed: Mar. 1, 2019

(30) Foreign Application Priority Data
Mar. 9, 2018 (JP) 2018-042496

(51) Int. Cl. F01D 1/02; F01D 25/26; F01D 9/02

(52) U.S. Cl. CPC F01D 1/023; F01D 25/26; F05D 2240/14; F05D 2240/12; F01D 9/02

(57) ABSTRACT

A steam turbine apparatus includes: an exhaust chamber which defines an exhaust flow passage; an outside casing including a radially outer wall portion formed on a radially outer side of the exhaust flow passage; an inside casing including a radially inner wall portion disposed on an inner side of the radially outer wall portion; a flow guide disposed on an end portion at a downstream side of the radially inner wall portion, the flow guide having a tubular shape whose distance from an axial center of the steam turbine increases along the flow direction; and at least one bypass flow passage connecting a first inner space upstream of the last stage rotor blade and a second inner space positioned at an outer side of the flow guide. The at least one bypass flow passage extends along an outer peripheral surface of the flow guide.

### TECHNICAL FIELD

The present disclosure relates to a steam turbine apparatus including an exhaust chamber which defines an exhaust flow passage inside, for guiding steam that has passed through the last stage rotor blade of a steam turbine to a condenser.

### BACKGROUND ART

Normally, steam having passed through the last stage rotor blade after performing work inside a steam turbine (inner casing), or exhaust gas, passes through an exhaust flow passage in an exhaust chamber before being condensed by a condenser. Steam flowing through the exhaust flow passage has its pressure recovered when passing through a diffuser flow passage inside the exhaust chamber, as the flow speed of the steam decreases. The greater the pressure recovery amount is between the turbine outlet and the condenser, the lower the turbine outlet pressure and the greater the pressure ratio between the inlet and the outlet of the turbine. Thus, the turbine efficiency increases. Herein, the pressure recovery amount inside the exhaust chamber is affected by the characteristics of the flow of steam flowing through the exhaust chamber and the shape of the internal structure of the exhaust chamber. Thus, some configurations have been proposed to improve the turbine efficiency.

For instance, Patent Document 1 discloses a steam turbine including a deflection member disposed on a flow guide that forms a diffuser flow passage of an exhaust chamber, so as to apply a swirl to a tip flow inside the diffuser flow passage and reduce loss at the time when the tip flow and the steam main flow are mixed.

Further, Patent Document 2 discloses an exhaust apparatus of a steam turbine which discharges steam downward from an exhaust chamber, wherein the flow passage of steam formed by the flow guide on the radially outer side of the exhaust chamber and the bearing cone on the radially inner side of the flow guide have a shape that is longer at the lower section than at the upper section.

### CITATION LIST

### Patent Literature

Patent Document 1: JP2011-220125A
Patent Document 2: JPH11-200814A

### SUMMARY

### Problems to be Solved

However, the steam turbine and the exhaust apparatus for a steam turbine disclosed in Patent Documents 1 and 2 have a risk of deterioration of the efficiency of the steam turbine due to turbulence of steam flow that flows at the radially outer side of the flow guide of the exhaust chamber. If turbulence occurs in the steam flow at the radially outer side of the flow guide, a reverse circulation flow is formed in the inner space positioned on the radially outer side of the flow guide, for instance, that flows in a direction opposite to the circulation flow formed by steam that flows at the radially outer side of the flow guide, and the fluid loss at the radially outer side of the flow guide of the exhaust flow passage increases. Furthermore, the swirl center of the circulation flow becomes closer to the radially outer side due to formation of the reverse circulation flow, and thus the circulation flow and the reverse circulation flow create a flow that separates from the inner peripheral surface of the flow guide, in the steam flowing near the downstream end portion of the flow guide with respect to the flow direction. When steam flowing through the exhaust flow passage separates from the flow guide covering the radially outer side of the diffuser flow passage, the pressure recovery performance in the exhaust chamber may decrease considerably. If such a turbulence occurs in the flow of steam flowing through the exhaust chamber, the fluid loss in the exhaust chamber increases, and the efficiency of the steam turbine may deteriorate.

In view of the above, an object of at least one embodiment of the present invention is to provide a steam turbine apparatus capable of reducing the fluid loss in the exhaust chamber and improving the efficiency of the steam turbine.

### Solution to the Problems

(1) According to at least one embodiment of the present invention, a steam turbine apparatus includes: an exhaust chamber which defines an exhaust flow passage inside, for guiding steam after passing through a last stage rotor blade of a steam turbine to a condenser; an outside casing including a radially outer wall portion formed on a radially outer side of the exhaust flow passage; an inside casing including a radially inner wall portion disposed on an inner side of the radially outer wall portion with respect to a radial direction; a flow guide disposed on an end portion at a downstream side of the radially inner wall portion with respect to a flow direction, the flow guide having a tubular shape whose distance from an axial center of the steam turbine increases along the flow direction towards downstream; and at least one bypass flow passage connecting a first inner space upstream of the last stage rotor blade and a second inner space positioned at an outer side of the flow guide with respect to the radial direction in the exhaust flow passage, the at least one bypass flow passage extending along an outer peripheral surface of the flow guide.

With the above configuration (1), the steam turbine apparatus includes the above described outer casing including a radially outer wall portion formed at the radially outer side of the exhaust flow passage, the inner casing including a radially inner wall portion disposed at the inner side of the radially outer wall portion with respect to the radial direction, the flow guide disposed on an end portion at the downstream side of the radially inner wall portion with respect to the flow direction and having a tubular shape whose distance from the axial center of the steam turbine increases toward the downstream side with respect to the flow direction, and at least one bypass flow passage connecting the first inner space at the upstream side of the last stage rotor blade and the second inner space positioned at the outer side of the flow guide in the exhaust flow passage with respect to the radial direction. With this steam turbine apparatus, it is possible to allow a part of steam in the first inner space to flow to the second inner space through the bypass flow passage. At this time, since the bypass flow passage extends along the outer peripheral surface of the flow guide, the steam flowing into the second inner space through the bypass flow passage forms a flow that is along the outer peripheral surface of the flow guide. Thus, the second inner space facing the outer peripheral surface of the flow guide is rectified by the steam flowing into the second inner space through the bypass flow passage, which brings about stable generation of the circulation flow formed by steam that flows at the radially outer side of the flow guide, whereby it possible to suppress formation of a reverse circulation flow that circulates in the opposite direction of the circulation flow. Furthermore, it is possible to suppress turbulence of steam flowing the vicinity of the end portion at the downstream side of the flow guide with respect to the flow direction thanks to the circulation flow and the reverse circulation flow formed at the radially outer side of the flow guide, and thereby it is possible to suppress separation of steam at the side of the flow guide and suppress reduction of the effective exhaust area in the exhaust chamber. Thus, it is possible to improve the pressure recovery amount of steam in the exhaust chamber. Accordingly, it is possible to reduce the fluid loss in the exhaust chamber, and improve the efficiency of the steam turbine.

(2) In some embodiments, in the above configuration (1), the bypass flow passage includes a through hole formed through the radially inner wall portion.

With the above configuration (2), it is possible to allow a part of steam in the first inner space to flow to the second inner space through the bypass flow passage formed by the through hole formed through the radially inner wall portion, and thus the steam flowing into the second inner space through the bypass flow passage hits the outer peripheral surface of the flow guide, whereby a flow along the outer peripheral surface of the flow guide is formed reliably. Thus, with the steam flowing into the second inner space through the bypass flow passage, it is possible to rectify the flow in the second inner space positioned at the outer side of the flow guide with respect to the radial direction reliably.

(3) In some embodiments, in the above configuration (1), the bypass flow passage is at least partially formed inside the flow guide.

With the above configuration (3), at least a part of the bypass flow passage is formed inside the flow guide disposed on the end portion at the downstream side of the radially inner wall portion with respect to the flow direction, and thus it is possible to reduce collision of steam flowing into the second inner space through the bypass flow passage with the outer peripheral surface of the flow guide compared to a case in which the bypass flow passage is formed by a through hole formed through the radially inner wall portion. Thus, it is possible to enhance the rectifying effect of steam flowing into the second inner space through the bypass flow passage. Furthermore, since it is possible to reduce collision of steam flowing into the second inner space through the bypass flow passage with the outer peripheral surface of the flow guide, it is possible to suppress erosion of the flow guide.

(4) In some embodiments, in the above configuration (3), the bypass flow passage has an outlet-side opening which is in communication with the second inner space and which is formed on an end surface at a downstream side of the flow guide with respect to the flow direction.

With the above configuration (4), since the outlet opening of the bypass flow passage that is in communication with the second inner space is formed on the end surface at the downstream side of the flow guide with respect to the flow direction, steam flowing into the second inner space through the bypass flow passage does not hit the outer peripheral surface of the flow guide. Thus, compared to a structure in which steam flowing into the second inner space via the bypass flow passage hits the outer peripheral surface of the flow guide, it is possible to enhance the rectifying effect of steam that flows into the second inner space through the bypass flow passage, and suppress erosion of the flow guide more effectively.

(5) In some embodiments, in any one of the above configurations (1) to (4), the bypass flow passage has an outlet-side opening which is in communication with the second inner space, the outlet-side opening having an axis which is inclined from the radial direction downstream with respect to the flow direction in a circumferential direction, in an axial-directional view of the steam turbine.

With the above configuration (5), steam flowing toward the second inner space from the outlet opening of the bypass flow passage flows along the axis of the outlet opening. Herein, since the axis of the outlet opening is disposed so as to be inclined from the radial direction toward the downstream side with respect to the flow direction in the circumferential direction, steam flowing toward the second inner space from the outlet opening of the bypass flow passage flows in the same direction as the flow direction of steam facing the inner peripheral surface of the flow guide. Thus, it is possible to suppress energy loss that is generated when steam that flows into the second inner space from the outlet opening of the bypass flow passage mixes with steam that faces the inner peripheral surface of the flow guide, and thus it is possible to reduce the fluid loss in the exhaust chamber effectively.

(6) In some embodiments, in any one of the above configurations (1) to (5), the at least one bypass flow passage includes a plurality of bypass flow passages disposed at intervals from one another in a circumferential direction. When the exhaust chamber is divided into, with respect to the circumferential direction, a condenser side where the condenser is provided and an opposite condenser side opposite to the condenser side, the plurality of bypass flow passages are formed only on the condenser side.

With the above configuration (6), the condenser side in the exhaust chamber has a lower static pressure than the opposite condenser side, and thus a flow of steam after passing through the last stage rotor blade of the steam turbine tends to flow along the axial direction. Thus, steam that flows through the condenser side in the exhaust chamber has a higher tendency to cause separation from the inner peripheral surface of the flow guide than steam that flows through the opposite condenser side. In this case, by forming the plurality of bypass flow passages on the condenser side where separation of steam is likely to occur, it is possible to suppress separation of steam from the inner peripheral surface of the flow guide at the condenser side. Furthermore, by not forming the plurality of bypass flow passages at the opposite condenser side, it is possible to prevent energy loss that is generated when steam flowing through the opposite condenser side mixes with steam flowing from the bypass flow passages. Thus, with the above configuration (6), it is possible to reduce fluid loss in the exhaust chamber effectively.

(7) In some embodiments, in any one of the above configurations (1) to (5), the at least one bypass flow passage includes a plurality of bypass flow passages disposed at intervals from one another in a circumferential direction. When the exhaust chamber is divided into, with respect to the circumferential direction, a condenser side where the condenser is provided and an opposite condenser side opposite to the condenser side, the plurality of bypass flow passages formed on the condenser side have smaller intervals between one another than the plurality of bypass flow passages formed on the opposite condenser side.

As described above, steam that flows through the condenser side in the exhaust chamber has a higher tendency to cause separation from the inner peripheral surface of the flow guide than steam that flows through the opposite condenser side. With the above configuration (7), the intervals between the plurality of bypass flow passages formed on the condenser side where separation of steam is more likely to occur are smaller than the intervals between the plurality of bypass flow passages formed on the opposite condenser side, and thereby it is possible to suppress separation of steam from the inner peripheral surface of the flow guide effectively at the condenser side. Furthermore, with the intervals between the plurality of bypass flow passages formed on the opposite condenser side where separation of steam is less likely to occur being greater than the intervals between the plurality of bypass flow passages formed on the condenser side, it is possible to suppress separation of steam from the inner peripheral surface of the flow guide effectively at the opposite condenser side, while suppressing energy loss that is generated when steam flowing through the opposite condenser side mixes with steam flowing from the bypass flow passages.

(8) In some embodiments, in any one of the above configurations (1) to (7), the flow guide having a tubular shape includes: a first flow guide having an arch shape and a first concave-shaped surface; and a second flow guide having an arch shape and a second concave-shaped surface which faces the first concave-shaped surface, and at least one of the first flow guide or the second flow guide is supported on the radially inner wall portion so as to enable adjustment of an angle with respect to an axis of the steam turbine.

Herein, the efficiency of the steam turbine may deteriorate due to environmental change. More specifically, the pressure inside the condenser changes due to environmental change such as seasonal temperature change. The change of the pressure inside the condenser brings about change in the flow of steam in the exhaust chamber. In a case where the temperature is particularly high, the pressure inside the condenser increases (becomes low vacuum), and thus turbulence occurs in the flow of steam flowing inside the exhaust chamber. If such a turbulence occurs in the flow of steam flowing through the exhaust chamber, the fluid loss in the exhaust chamber increases, and the efficiency of the steam turbine may deteriorate. With the above configuration (8), the flow guide having a tubular shape includes the first flow guide having an arch shape and the second flow guide having an arch shape. Further, at least one of the first flow guide or the second flow guide is supported on the radially inner wall portion so as to enable adjustment of the angle with respect to the axis of the steam turbine. Thus, it is possible to improve the efficiency of the steam turbine by adjusting the angles of the first flow guide and the second flow guide in response to the above described environmental change.

(9) In some embodiments, in the above configuration (8), the first flow guide includes a first fastening portion fastened to an end portion at the downstream side of the radially inner wall portion by bolt fastening, the second flow guide includes a second fastening portion fastened to the end portion at the downstream side of the radially inner wall portion by bolt fastening, and the steam turbine apparatus further includes a first elastic member nipped between the end portion at the downstream side of the radially inner wall portion and the first fastening portion and a second elastic member nipped between the end portion at the downstream side of the radially inner wall portion and the second fastening portion.

With the above configuration (9), the first flow guide and the second flow guide are biased by elastic forces of the first elastic member and the second elastic member, and thus it is possible to prevent loosening of the flow guides. Specifically, in a case where the first fastening portion and the second fastening portion are bended with respect to the guide surfaces of the first flow guide and the second flow guide for guiding steam, and the bolts for bolt fastening are inserted through at positions eccentrically displaced in the radial direction from the axes of the first fastening portion and the second fastening portion, it is possible to adjust the angles of the first flow guide and the second flow guide easily by adjusting the fastening force of bolt fastening. Thus, it is possible to adjust the angles of the first flow guide and the second flow guide in a short period of time, and thus it is possible to reduce the time required to start the steam turbine.

(10) In some embodiments, in any one of the above configurations (1) to (7), the first flow guide having a tubular shape includes: a first flow guide having an arch shape and a first concave-shaped surface; and a second flow guide having an arch shape and a second concave-shaped surface which faces the first concave-shaped surface, and the radially inner wall portion includes an engageable portion on the end portion at the downstream side of the radially inner wall portion, the first flow guide includes a first engaging portion which is engageable with the engageable portion, and the second flow guide includes a second engaging portion which is engageable with the engageable portion.

With the above configuration (10), the flow guide having a tubular shape includes the first flow guide having an arch shape and the second flow guide having an arch shape. Further, since the first flow guide and the second flow guide include the first engaging portion and the second engaging portion that are engageable with the engageable portion of the radially inner wall portion, the first flow guide and the second flow guide can be attached to and removed from the radially inner wall portion more easily than a flow guide formed to have a tubular shape, which makes it possible to perform replacement in a shorter period of time. Thus, it is possible to reduce the time required to start operation of the steam turbine. Further, while the efficiency of the steam turbine may deteriorate due to environmental change as described above, it is possible to improve the efficiency of the steam turbine by replacing the flow guide with one that is more suitable to the environment.

(11) In some embodiments, in the above configuration (10), the first flow guide is configured to be capable of being fastened by bolt fastening in a state where the engageable portion is engaged with the first engaging portion, and the second flow guide is configured to be capable of being fastened by bolt fastening in a state where the engageable portion is engaged with the second engaging portion.

With the above configuration (11), the first flow guide and the second flow guide are structured so as not to be easily detached from the radially inner wall portion, as the first engaging portion and the second engaging portion are engaged with the engageable portion. Thus, it is possible to reduce the number of bolts required for bolt fastening, compared to a structure where the first and second engaging portions are not engaged with the engageable portion. Furthermore, as a smaller number of bolts are required for bolt fastening, the first flow guide and the second flow guide can be attached to and removed from the radially inner wall portion even more easily, and it is possible to reduce the time required to start operation of the steam turbine even further.

(12) In some embodiments, in any one of the above configurations (1) to (11), the outer casing includes a first outer casing having an opening portion and a second outer casing capable of closing the opening portion of the first outer casing, the second outer casing being connected rotatably to the first outer casing via a hinge.

For instance, in a case where the second outer casing and the first outer casing are completely separable, it is necessary to determine the position when attaching the second outer casing to the first outer casing, which may take some time. With the above configuration (12), the second outer casing is capable of closing the opening portion of the first outer casing thanks to the hinge, and is also connected to the first outer casing rotatably via the hinge. Accordingly, it is possible to rotate and open the second outer casing relative to the first outer casing. Furthermore, since the second outer casing is connected to the first outer casing via the hinge, it is possible to cut or simplify the position determining work when closing the opening portion of the first outer casing. Thus, it is possible to reduce the time required to open and close the second outer casing, and thus it is possible to improve the maintenance performance such as replacement of the diffuser (flow guide or bearing cone). Further, while the efficiency of the steam turbine may deteriorate due to environmental change as described above, it is possible to improve the efficiency of the steam turbine by replacing the diffuser with one that is more suitable to the environment.

### Advantageous Effects

According to an embodiment of the present invention, provided is a steam turbine apparatus capable of reducing the fluid loss in the exhaust chamber and improving the efficiency of the steam turbine.

### BRIEF DESCRIPTION OF DRAWINGS

FIG. 1 is a schematic cross-sectional view, taken along the axial direction, of a steam turbine including a steam turbine apparatus according to an embodiment of the present invention.

FIG. 2 is a partial enlarged cross-sectional view, taken along the axial direction, of a steam turbine apparatus according to an embodiment of the present invention.

FIG. 3 is a schematic cross-sectional view taken along line A-A in FIG. 2.

FIG. 4 is a partial enlarged cross-sectional view, taken along the axial direction, of a steam apparatus according to a comparative example.

FIG. 5 is a partial enlarged cross-sectional view, taken along the axial direction, of a steam turbine apparatus according to another embodiment of the present invention.

FIG. 6 is a schematic diagram for describing the bypass flow passage according to an embodiment of the present invention, taken along a direction orthogonal to the axial direction of the steam turbine.

FIG. 7 is a schematic partial enlarged diagram for describing the bypass flow passage according to another embodiment of the present invention, which is disposed inclined from the axial direction of the steam turbine in the circumferential direction, taken along a direction orthogonal to the axial direction of the steam turbine.

FIG. 8 is a schematic diagram for describing the bypass flow passage according to another embodiment of the present invention, disposed only at the condenser side, taken along a direction orthogonal to the axial direction of the steam turbine.

FIG. 9 is a schematic diagram for describing bypass flow passages according to another embodiment of the present invention, which are disposed so as to have smaller intervals among one another in the circumferential direction at the condenser side than at the opposite condenser side, taken along a direction orthogonal to the axial direction of the steam turbine.

FIG. 10 is a partial enlarged cross-sectional view, taken along the axial direction of a steam turbine apparatus, for describing the first flow guide and the second flow guide according to an embodiment of the present invention.

FIG. 11 is a perspective view of the first flow guide and the second flow guide depicted in FIG. 10.

FIG. 12 is a partial enlarged cross-sectional view, taken along the axial direction of the steam turbine apparatus, for describing the flow guide according to a comparative example.

FIG. 13 is a partial enlarged cross-sectional view, taken along the axial direction of a steam turbine apparatus, for describing the first flow guide and the second flow guide according to another embodiment of the present invention.

FIG. 14 is a perspective view of the first flow guide and the second flow guide depicted in FIG. 13.

FIG. 15 is a schematic diagram for describing an outer casing and a crane that suspends the outer casing according to an embodiment of the present invention, showing a state where the first outer casing is closed with the second outer casing, along a direction orthogonal to the axial direction of the steam turbine.

FIG. 16 is a schematic diagram showing a state where the second outer casing depicted in FIG. 15 is opened 180 degrees relative to the first outer casing, along a direction orthogonal to the axial direction of the steam turbine.

FIG. 17 is a schematic diagram for describing outer casings and a crane that suspends the outer casings according to another embodiment of the present invention, showing a state where the first outer casing is closed with the second outer casings along a direction orthogonal to the axial direction of the steam turbine.

FIG. 18 is a schematic diagram showing a state where the two second outer casings in FIG. 17, disposed on both of the right and left sides of the drawing, are opened 90 degrees relative to the first outer casing, along a direction orthogonal to the axial direction of the steam turbine.

FIG. 19 is a schematic diagram for describing an outer casing and a crane that suspends the outer casing according to a comparative example, along a direction orthogonal to the axial direction of the steam turbine.

### DETAILED DESCRIPTION

Embodiments of the present invention will now be described in detail with reference to the accompanying drawings. It is intended, however, that unless particularly identified, dimensions, materials, shapes, relative positions and the like of components described in the embodiments shall be interpreted as illustrative only and not intended to limit the scope of the present invention.

For instance, an expression of relative or absolute arrangement such as “in a direction”, “along a direction”, “parallel”, “orthogonal”, “centered”, “concentric” and “coaxial” shall not be construed as indicating only the arrangement in a strict literal sense, but also includes a state where the arrangement is relatively displaced by a tolerance, or by an angle or a distance whereby it is possible to achieve the same function.

For instance, an expression of an equal state such as “same” “equal” and “uniform” shall not be construed as indicating only the state in which the feature is strictly equal, but also includes a state in which there is a tolerance or a difference that can still achieve the same function.

Further, for instance, an expression of a shape such as a rectangular shape or a cylindrical shape shall not be construed as only the geometrically strict shape, but also includes a shape with unevenness or chamfered corners within the range in which the same effect can be achieved.

On the other hand, an expression such as “comprise”, “include”, “have”, “contain” and “constitute” are not intended to be exclusive of other components.

The same features may be indicated by the same reference numerals and not described in detail.

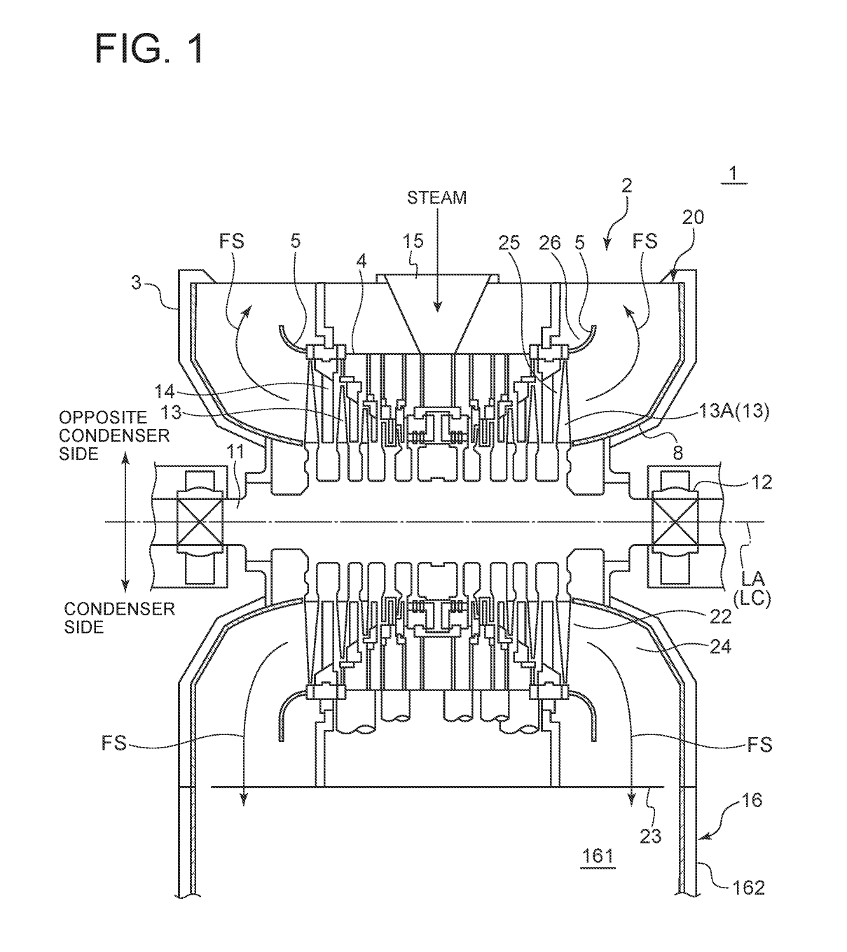

Firstly, the overall structure of a steam turbine including a steam turbine apparatus according to some embodiments will be described. FIG. 1 is a schematic cross-sectional view, taken along the axial direction, of a steam turbine including a steam turbine apparatus according to an embodiment of the present invention. As depicted in FIG. 1, the steam turbine 1 includes a rotor 11 having an elongated rod shape, a bearing 12 that supports the rotor 11 rotatably, a plurality of stages of rotor blades 13 disposed on the rotor 11, an inner casing 4 that accommodates the rotor 11 and the rotor blades 13, a plurality of stages of stationary vanes 14 disposed on the inner casing 4 so as to face the rotor blades 13, and an outer casing 3 disposed at the outer side of the inner casing 4 with respect to the radial direction. In the steam turbine 1, steam introduced into the inner casing 4 from the steam inlet 15 expands when passing through the stationary vanes 14 so that the speed of the steam increases, and the steam performs work on the rotor blades 13 and rotates the rotor 11. Further, as depicted in FIG. 1, the axial center LA of the steam turbine 1 may exist on the center axis LC of the rotor 11.

Further, the steam turbine 1 includes an exhaust chamber 20. As depicted in FIG. 1, the exhaust chamber 20 is positioned at the downstream side of the rotor blades 13 and the stationary vanes 14. After passing through the rotor blades 13 and the stationary vanes 14 in the inner casing 4, steam (steam flow FS) flows into the exhaust chamber 20 from an exhaust chamber inlet 22 positioned at the downstream side, with respect to the flow direction of the steam, of the last stage rotor blade 13A, which is the rotor blade positioned most downstream with respect to the flow direction, passes through the exhaust flow passage 21 formed inside the exhaust chamber 20, and exits the steam turbine 1 outside from an exhaust chamber outlet 23 disposed on a lower part of the exhaust chamber 20. Further, in the embodiment depicted in FIG. 1, the exhaust chamber outlet 23 is positioned opposite to the steam inlet 15 across the center axis LC of the rotor 11. Nevertheless, in some other embodiments, the exhaust chamber outlet 23 may be positioned at the same side as the steam inlet 15 with respect to the center axis LC of the rotor 11, or at a position distanced in the horizontal direction from the center axis LC of the rotor 11.

In the embodiment depicted in FIG. 1, a condenser 16 is disposed below the exhaust chamber 20. The condenser 16 includes a body 162 having a condenser inlet 161 formed thereon, into which steam flows from the exhaust chamber outlet 23 of the exhaust chamber 20, and a plurality of heat-transfer tubes (not depicted) disposed inside the body 162. Cooling water cooled by sea water or the like flows inside the plurality of heat-transfer tubes. In this case, the plurality of heat-transfer tubes condense steam that flows into the body 162 via the condenser inlet 161 from the exhaust chamber outlet 23 of the exhaust chamber 20.

Furthermore, as depicted in FIG. 1, the steam turbine 1 includes a bearing cone 8 disposed so as to cover the radially outer side of the bearing 12, and a flow guide 5 disposed on the outer side, with respect to the radial direction, of the bearing cone 8 inside the exhaust chamber 20. The bearing cone 8 and the flow guide 5 are formed to have a tubular shape whose distance from the axial center LA of the steam turbine 1 increases toward the downstream side with respect to the flow direction (outer side in the axial direction). Inside the exhaust chamber 20, a diffuser flow passage 24 having an annular shape is formed by the bearing cone 8 and the flow guide 5. The diffuser flow passage 24 is in communication with the first inner space 25 at the upstream side of the last stage rotor blade 13A with respect to the flow direction, and has a shape whose cross-sectional area gradually increases toward the downstream side with respect to the flow direction. Further, as the steam flow FS having a high speed passes through the last stage rotor blade 13A of the steam turbine 1 and then flows into the diffuser flow passage 24, the speed of the steam flow FS is reduced, and the kinetic energy of the steam is converted into pressure (static pressure recovery). Further, as depicted in FIG. 1, the center axes of the bearing cone 8 and the flow guide 5 may exist on the same line as the center axis LC of the rotor 11.

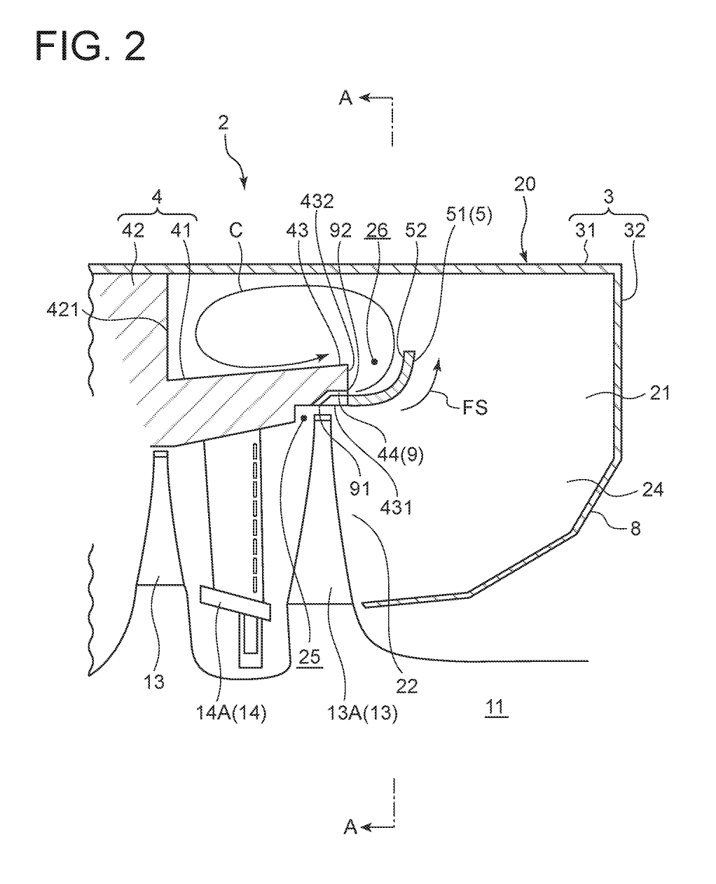

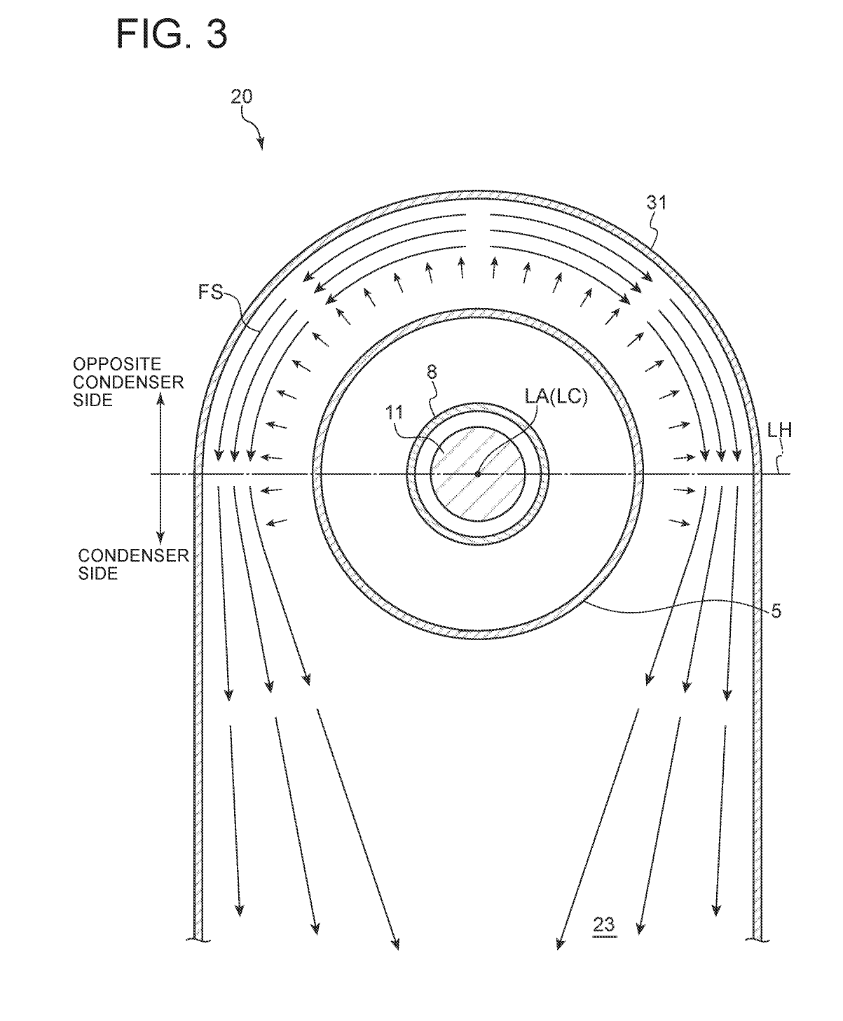

Next, with reference to FIGS. 1 to 9, the configuration of the steam turbine apparatus 2 according to some embodiments will be described. Herein, FIG. 2 is a partial enlarged cross-sectional view, taken along the axial direction, of a steam turbine apparatus according to an embodiment of the present invention. FIG. 3 is a schematic cross-sectional view taken along line A-A in FIG. 2. In FIG. 3, the bypass flow passage 9 is omitted from the drawing, and the condenser side is depicted together.

As depicted in FIG. 1, the steam turbine apparatus 2 according to some embodiments includes an exhaust chamber 20 which defines an exhaust flow passage 21 inside, for guiding steam that has passed through the last stage rotor blade 13A of the steam turbine 1 to the condenser 16. Further, as depicted in FIG. 2, the steam turbine apparatus 2 includes the above described outer casing 3 including a radially outer wall portion 31 formed at the radially outer side of the exhaust flow passage 21, the above described inner casing 4 including a radially inner wall portion 41 disposed at the inner side of the radially outer wall portion with respect to the radial direction, a flow guide 5 disposed on an end portion 43 at the downstream side of the radially inner wall portion 41 with respect to the flow direction (outer side in the axial direction) and having a tubular shape whose distance from the axial center LA of the steam turbine 1 increases toward the downstream side with respect to the flow direction (the right side of FIG. 2, outer side in the axial direction), and at least one bypass flow passage 9 connecting the first inner space 25 at the upstream side of the last stage rotor blade 13A and the second inner space 26 positioned at the outer side of the flow guide 5 in the exhaust flow passage 21 with respect to the radial direction.

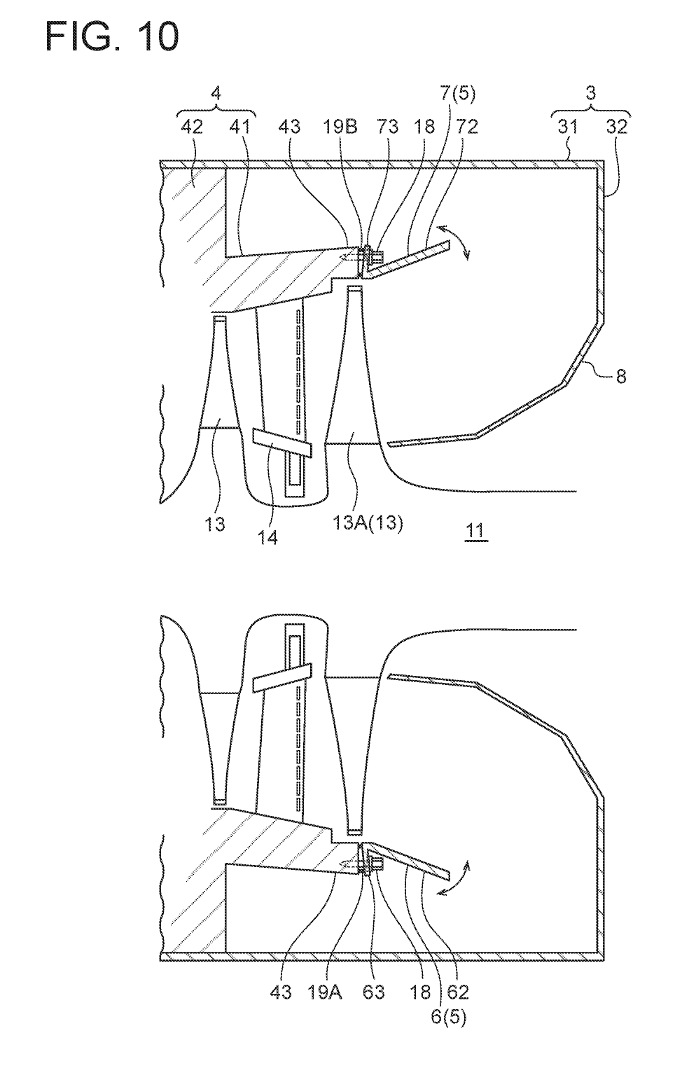

Further, the at least one bypass flow passage 9 extends along the outer peripheral surface 52 of the flow guide 5. Herein, the bypass flow passage 9 extending along the outer peripheral surface 52 of the flow guide 5 only means that the steam flowing through the bypass flow passage 9 is capable of flowing out along the outer peripheral surface 52 of the flow guide 5 from the outlet opening 92, and it is sufficient if the axis of the outlet opening 92 and the axis of a portion of the bypass flow passage 9 connecting to the outlet opening 92 are along the outer peripheral surface 52 of the flow guide 5. Further, in the embodiment depicted in FIG. 2, the flow guide 5 is formed to have an arc shape in a cross section along the axial direction. Nevertheless, the flow guide 5 may have a linear shape (see FIG. 10) or a shape including a plurality of lines, in a cross section along the axial direction.

As depicted in FIG. 2, the outer casing 3 includes the radially outer wall portion 31 extending along the axial direction, and a first wall portion 32 extending along the radial direction. The first wall portion 32 has an outer end, with respect to the radial direction (the upper end portion in the drawing), connected to an outer end of the radially outer wall portion 31 with respect to the axial direction (the right end portion in the drawing). As depicted in FIG. 2, the first wall portion 32 has an end portion, at the inner side of the radial direction (the lower end portion in the drawing), connected to a downstream end portion of the bearing cone 8 with respect to the flow direction. Further, while the bearing cone 8 is formed to have a shape including a plurality of straight lines in a cross section along the axial direction as depicted in FIG. 2, the bearing cone 8 may be formed to have an arc shape in a cross section along the axial direction. Furthermore, in some other embodiments, the end portion at the downstream side of the bearing cone 8 with respect to the flow direction may be connected to an end portion at the outer side of the radially outer wall portion 31 with respect to the axial direction. Further, in some other embodiments, the bearing cone 8 may be accommodated inside the outer casing 3.

As depicted in FIG. 3, in the circumferential direction, the exhaust chamber 20 is divided into the condenser side where the exhaust chamber outlet 23 and the condenser 16 are disposed, and the opposite condenser side opposite to the side where the exhaust chamber outlet 23 and the condenser 16 are disposed. As depicted in FIG. 3, the boundary dividing the condenser side and the opposite condenser side is the horizontal line LH. Herein, the horizontal line LH is a line extending along the horizontal direction (right-left direction in FIG. 3) orthogonal to the axis line passing through the center axis LC of the rotor 11. As depicted in FIG. 3, the radially outer wall portion 31 is formed to have a semi-annular shape at the condenser side and a shape extending along the vertical direction at the opposite condenser side, in a cross-section along a direction in which the horizontal line LH extends.

Further, in the embodiment depicted in FIG. 2, the inner casing 4 includes the radially inner wall portion 41 extending along the axial direction and the second wall portion 42 connecting to the radially outer side of the radially inner wall portion 41 and extending along the radial direction. The inner casing 4 is supported on the outer casing 3 via the second wall portion 42.

The bypass flow passage 9 includes, as depicted in FIG. 2, an inlet opening 91 that is in communication with the first inner space 25 and an outlet opening 92 that is in communication with the second inner space 26.

The above described first inner space 25 is a space formed at the upstream side of the last stage rotor blade 13A, as depicted in FIG. 2. More specifically, the first inner space 25 is a space positioned on the inner side of the radially inner wall portion 41 with respect to the radial direction, and on the inner side of the last stage rotor blade 13A with respect to the axial direction. Preferably, the first inner space 25 is a space disposed at the inner side of the last stage rotor blade 13A with respect to the axial direction, and at the outer side of the last stage stationary vane 14A with respect to the axial direction. In this case, steam that has performed work on the rotor blade 13A in front of the last stage rotor blade 13A is utilized, and thus it is possible to suppress deterioration of the efficiency of the steam turbine 1. Herein, the inner side of the last stage rotor blade 13A with respect to the axial direction includes a space positioned on the outer side of the last stage rotor blade A with respect to the radial direction. Similarly, the outer side of the last stage stationary vane 14A with respect to the axial direction includes a space positioned on the inner side of the last stage stationary vane 14A with respect to the radial direction.

The above described second inner space 26 is, as depicted in FIG. 2, a space positioned on the outer side of the flow guide 5 in the exhaust flow passage 21 with respect to the radial direction. More specifically, the first inner space 25 is a space positioned on the inner side of the outer end of the flow guide 5 with respect to the axial direction and on the outer side of an end surface 421 of the second wall portion 42 with respect to the axial direction.

The bypass flow passage 9 is, as depicted in FIG. 2, formed by a through hole 44 formed through the radially inner wall portion 41. Further, the inlet opening 91 of the bypass flow passage 9 is, as depicted in FIG. 2, formed on a position that faces the end surface of the last stage rotor blade 13A, on the inner peripheral surface 431 of the end portion 43 at the downstream side of the radially inner wall portion 41 with respect to the flow direction. Furthermore, the outlet opening 92 of the bypass flow passage 9 is, as depicted in FIG. 2, formed on a position on the outer side of the flow guide 5, with respect to the radial direction, on the end surface 432 at the downstream side of the end portion 43. Further, as depicted in FIG. 2, the through hole 44 is formed such that the axis bends midway, but the axis at the outlet opening 92 is along the outer peripheral surface 52 of the flow guide 5. In another embodiment, the through hole 44 may have a shape whose axis has a linear shape or an arc shape.

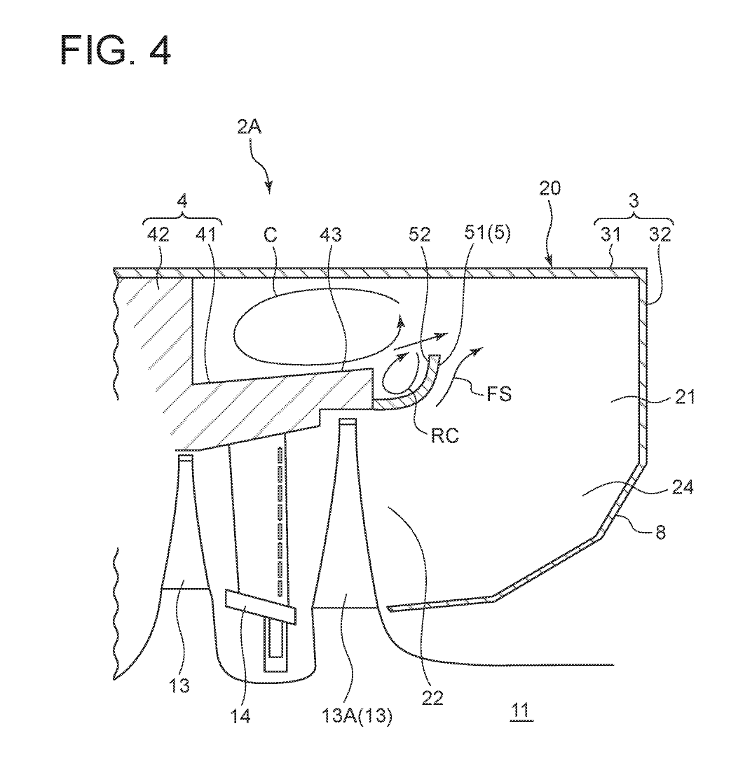

FIG. 4 is a partial enlarged cross-sectional view, taken along the axial direction, of a steam turbine including a steam turbine apparatus according to a comparative example. In FIG. 4, members having the same reference numerals as those in the embodiment depicted in FIG. 2 are not described again. The steam turbine apparatus 2A of a comparative example depicted in FIG. 2 includes the above described outer casing 3, the above described inner casing 4, and the above described flow guide 5, but does not include the above described bypass flow passage 9. The inventors of the present invention conducted intensive research and found the following. That is, in the steam turbine apparatus 2A of the comparative example, as depicted in FIG. 4, a reverse circulation flow RC is formed, which circulates in an opposite direction to the circulation flow C formed by steam flowing through the outer side of the flow guide 5 with respect to the radial direction, whereby the fluid loss at the outer side of the flow guide 5 of the exhaust flow passage 21 with respect to the radial direction increases. Furthermore, as depicted in FIG. 4, due to formation of the reverse circulation flow RC, the swirl center of the circulation flow C becomes closer to the outer side with respect to the radial direction inside the exhaust chamber 20, and thus the circulation flow C and the reverse circulation flow RC create a flow that separates from the inner peripheral surface 51 of the flow guide 5, in the steam flowing near the end portion at the downstream side of the flow guide with respect to the flow direction. When steam flowing through the exhaust flow passage 21 separates from the flow guide 5 covering the radially outer side of the diffuser flow passage 24, the pressure recovery performance in the exhaust chamber 20 may decrease considerably. The above phenomenon may occur in the configurations disclosed in Patent Documents 1 and 2.

Thus, the inventors of the present invention arrived at suppressing separation at the side of the flow guide 5 of the steam flowing through the exhaust flow passage 21 by rectifying the steam flowing through the outer side of the flow guide 5 with respect to the radial direction by using steam flowing through the above described bypass flow passage 9.

As described above, the steam turbine apparatus 2 according to some embodiments, as depicted in FIG. 2, includes the exhaust chamber 20 that defines the above described exhaust flow passage 21 inside, the above described outer casing 3 including the above described radially outer wall portion 31, the above described inner casing 4 including the above described radially inner wall portion 41, the above described flow guide 5, and the above described at least one bypass flow passage 9.

With the above configuration, the steam turbine apparatus 2 includes the above described outer casing 3 including a radially outer wall portion 31 formed at the radially outer side of the exhaust flow passage 21, the inner casing 4 including a radially inner wall portion 41 disposed at the inner side of the radially outer wall portion 31 with respect to the radial direction, the flow guide 5 disposed on an end portion 43 at the downstream side of the radially inner wall portion 41 with respect to the flow direction and having a tubular shape whose distance from the axial center of the steam turbine 1 increases toward the downstream side with respect to the flow direction, and at least one bypass flow passage 9 connecting the first inner space 25 at the upstream side of the last stage rotor blade 13A and the second inner space 26 positioned at the outer side of the flow guide 5 in the exhaust flow passage 21 with respect to the radial direction.

With this steam turbine apparatus 2, it is possible to allow a part of steam in the first inner space 25 to flow to the second inner space 26 through the bypass flow passage 9. At this time, since the bypass flow passage 9 extends along the outer peripheral surface 52 of the flow guide 5, the steam flowing into the second inner space 26 through the bypass flow passage 9 forms a flow that is along the outer peripheral surface 52 of the flow guide 5. Thus, steam flow in the second inner space 26 facing the outer peripheral surface 52 of the flow guide 5 is rectified by the steam flowing into the second inner space 26 through the bypass flow passage 9, which brings about stable generation of the circulation flow C formed by steam that flows at the radially outer side of the flow guide 5, whereby it possible to suppress formation of the reverse circulation flow RC (see FIG. 4) that circulates in the opposite direction of the circulation flow C. Furthermore, it is possible to suppress turbulence of steam flowing the vicinity of the end portion 43 at the downstream side of the flow guide 5 with respect to the flow direction thanks to the circulation flow C and the reverse circulation flow RC formed at the radially outer side of the flow guide 5, and thereby it is possible to suppress separation of steam at the side of the flow guide 5 and suppress reduction of the effective exhaust area in the exhaust chamber 20. Thus, it is possible to improve the pressure recovery amount of steam in the exhaust chamber 20. Accordingly, it is possible to reduce the fluid loss in the exhaust chamber 20, and improve the efficiency of the steam turbine 1.

In some embodiments, as depicted in FIG. 2, the above described bypass flow passage 9 is formed by a through hole 44 formed through the radially inner wall portion 41.

With the above configuration, it is possible to allow a part of steam in the first inner space 25 to flow to the second inner space 26 through the bypass flow passage 9 formed by the through hole 44 formed through the radially inner wall portion 41, and thus the steam flowing into the second inner space 26 through the bypass flow passage 9 hits the outer peripheral surface 52 of the first inner space 25, whereby a flow along the outer peripheral surface 52 of the flow guide 5 is formed reliably. Thus, with the steam flowing into the second inner space 26 through the bypass flow passage 9, it is possible to rectify the flow in the second inner space 26 positioned at the outer side of the flow guide 5 with respect to the radial direction reliably.

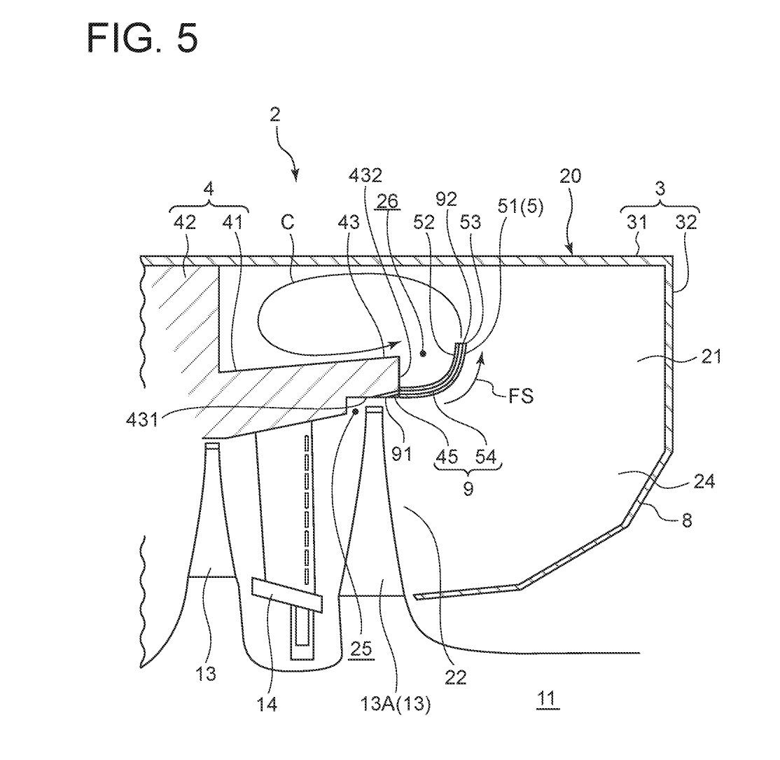

FIG. 5 is a partial enlarged cross-sectional view, taken along the axial direction, of a steam turbine apparatus according to another embodiment of the present invention. In some embodiments, as depicted in FIG. 5, at least a part of the above described bypass flow passage 9 is formed inside the flow guide 5. The bypass flow passage 9 is, as depicted in FIG. 5, formed by the first through hole 45 formed through the end portion 43 at the downstream side of the radially inner wall portion 41 and the second through hole 54 formed inside the flow guide 5. The second through hole 54 is formed to have a shape whose axis extends along the outer peripheral surface 52 of the flow guide 5, as depicted in FIG. 5.

Further, the inlet opening 91 of the bypass flow passage 9 is, as depicted in FIG. 5, an inlet opening of the first through hole 45, and is formed on a position that faces the end surface of the last stage rotor blade 13A, on the inner peripheral surface 431 of the end portion 43 at the downstream side of the radially inner wall portion 41 with respect to the flow direction. Furthermore, the outlet opening 92 of the bypass flow passage 9 is, as depicted in FIG. 5, formed on the end surface 53 at the downstream side of the flow guide 5 with respect to the flow direction. Further, in some other embodiments, the outlet opening 92 of the bypass flow passage 9 may be formed on the outer peripheral surface 52 of the flow guide 5.

Further, as depicted in FIG. 5, the outlet opening of the first through hole 45 is formed on the end surface 432 at the downstream side of the end portion 43, and is in communication with the inlet opening of the second through hole 54 formed on the end surface at the inner side of the flow guide 5 with respect to the axial direction.

With the above configuration, at least a part of the bypass flow passage 9 is formed inside the flow guide 5 disposed on the end portion 43 at the downstream side of the radially inner wall portion 41 with respect to the flow direction, and thus it is possible to reduce collision of steam flowing into the second inner space 26 through the bypass flow passage 9 with the outer peripheral surface 52 of the flow guide 5 compared to a case in which the bypass flow passage 9 is formed by the through hole 44 formed through the radially inner wall portion 41. Thus, it is possible to enhance the rectifying effect of steam flowing into the second inner space 26 through the bypass flow passage 9. Furthermore, since it is possible to reduce collision of steam flowing into the second inner space 26 through the bypass flow passage 9 with the outer peripheral surface 52 of the flow guide 5, it is possible to suppress erosion of the flow guide 5.

In some embodiments, as depicted in FIG. 5, the outlet opening 92 of the above described bypass flow passage 9 that is in communication with the second inner space 26 is formed on the end surface 53 at the downstream side of the flow guide 5 with respect to the flow direction.

With the above configuration, since the outlet opening 92 of the bypass flow passage 9 that is in communication with the second inner space 26 is formed on the end surface 53 at the downstream side of the flow guide 5 with respect to the flow direction, steam flowing into the second inner space 26 through the bypass flow passage 9 does not hit the outer peripheral surface 52 of the flow guide 5. Thus, compared to a structure in which steam flowing into the second inner space 26 via the bypass flow passage 9 hits the outer peripheral surface 52 of the flow guide 5, it is possible to enhance the rectifying effect of steam that flows into the second inner space 26 through the bypass flow passage 9, and suppress erosion of the flow guide 5 more effectively.

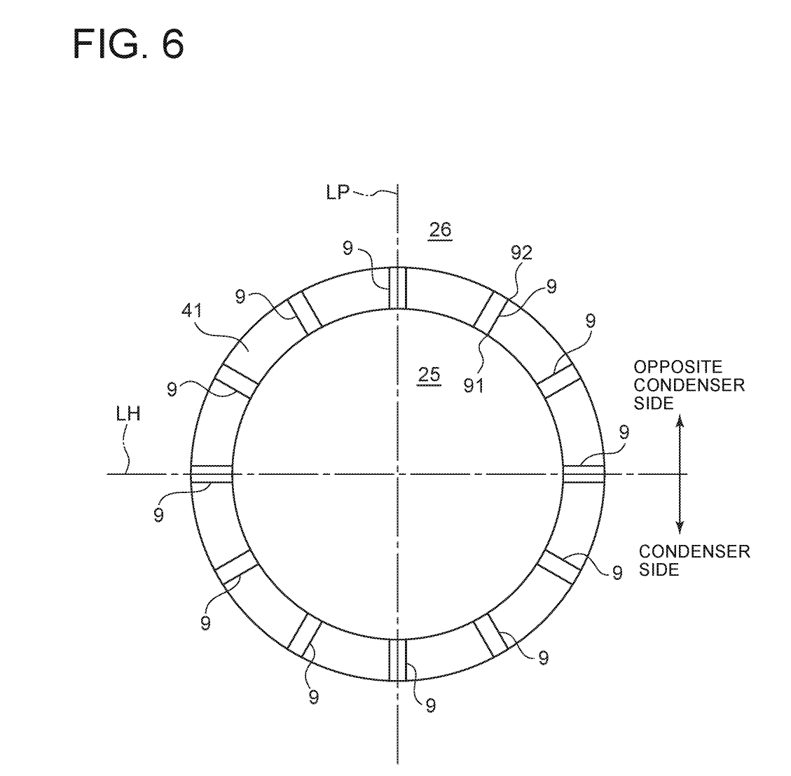

FIG. 6 is a schematic diagram for describing the bypass flow passage according to an embodiment of the present invention, taken along a direction orthogonal to the axial direction of the steam turbine. In some embodiments, as depicted in FIG. 6, the above described bypass flow passage 9 includes a plurality of bypass flow passages 9 disposed with regular intervals between one another in the circumferential direction. Further, each bypass flow passage 9 has an axis that extends along the radial direction at the outlet opening 92. In this case, it is possible to suppress separation of steam from the inner peripheral surface 51 of the flow guide 5 at the condenser side and the opposite condenser side.

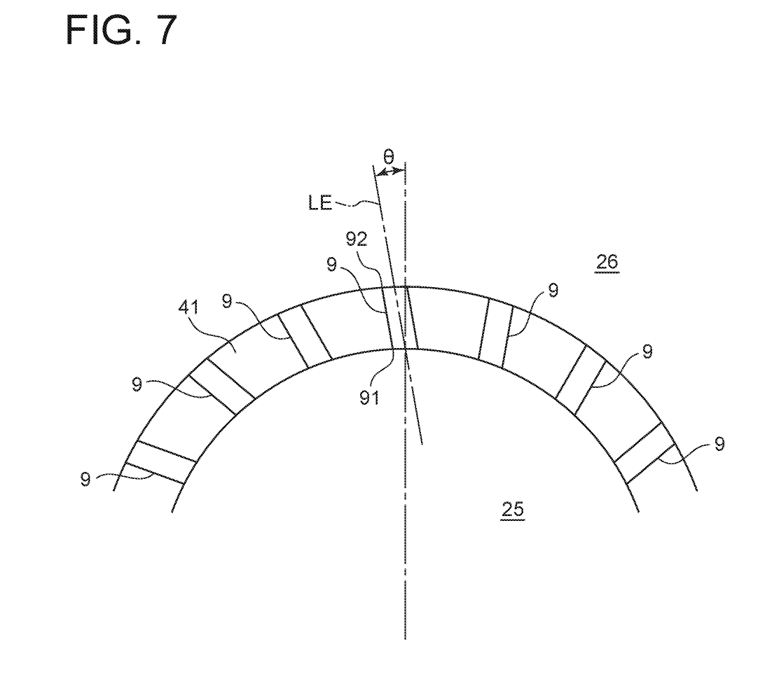

FIG. 7 is a schematic partial enlarged diagram for describing the bypass flow passage according to another embodiment of the present invention, which is disposed inclined from the axial direction of the steam turbine in the circumferential direction, taken along a direction orthogonal to the axial direction of the steam turbine. In some embodiments, as depicted in FIG. 7, the outlet opening 92 of the above described bypass flow passage 9 that is in communication with the second inner space 26 is formed such that the axis of the outlet opening 92 is inclined from the radial direction toward the downstream side with respect to the flow direction in the circumferential direction, in a view of the direction of the axis (axial directional view) of the steam turbine 1. In the embodiment depicted in FIG. 7, the rotor 11 rotates in the anticlockwise direction, and a flow of steam inclined in the anticlockwise direction is formed inside the exhaust chamber 20. Furthermore, the axis LE of the outlet opening 92 is, as depicted in FIG. 7, inclined from the radial direction by θ angular degrees in the anticlockwise direction.

With the above configuration, steam flowing toward the second inner space 26 from the outlet opening 92 of the bypass flow passage 9 flows along the axis of the outlet opening 92. Herein, since the axis LE of the outlet opening 92 is disposed so as to be inclined from the radial direction toward the downstream side with respect to the flow direction in the circumferential direction, steam flowing toward the second inner space 26 from the outlet opening 92 of the bypass flow passage 9 flows in the same direction as the flow direction of steam facing the inner peripheral surface 51 of the flow guide 5. Thus, it is possible to suppress energy loss that is generated when steam that flows into the second inner space 26 from the outlet opening 92 of the bypass flow passage 9 mixes with steam that faces the inner peripheral surface 51 of the flow guide 5, and thus it is possible to reduce the fluid loss in the exhaust chamber 20 effectively.

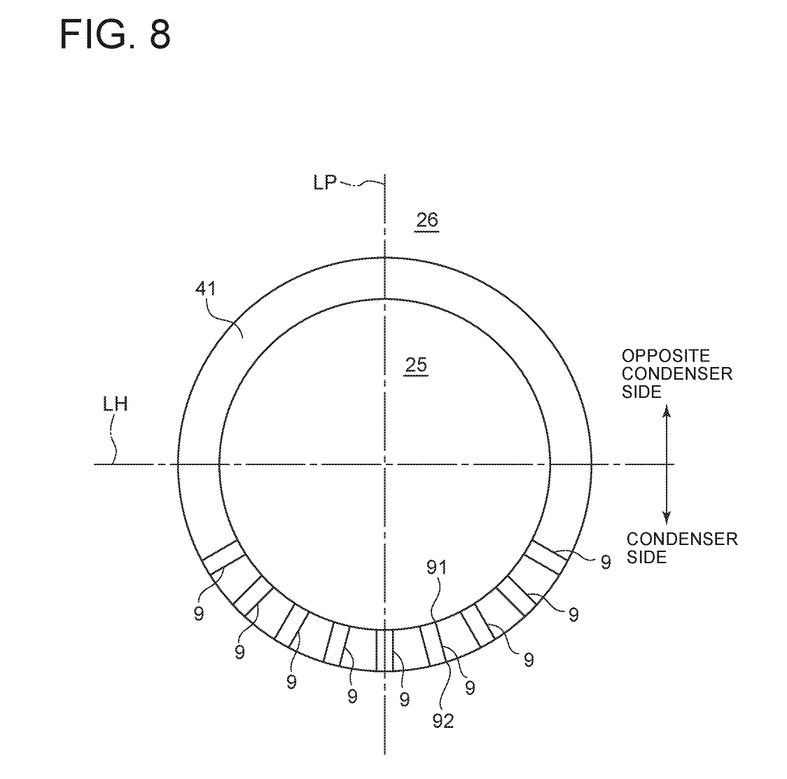

FIG. 8 is a schematic diagram for describing the bypass flow passage according to another embodiment of the present invention, disposed only at the condenser side, taken along a direction orthogonal to the axial direction of the steam turbine. In some embodiments, as depicted in FIG. 8, the above described bypass flow passage 9 includes a plurality of bypass flow passages 9 disposed with intervals between one another in the circumferential direction. Further, as depicted in FIG. 8, when the above described exhaust chamber 20 is divided into the condenser side where the condenser 16 is disposed and the opposite condenser side opposite to the side where the condenser 16 is disposed in the circumferential direction, the above described bypass flow passages 9 are formed only on the condenser side.

With the above configuration, the condenser side in the exhaust chamber 20 has a lower static pressure than the opposite condenser side, and thus a flow of steam after passing through the last stage rotor blade 13A of the steam turbine 1 tends to flow along the axial direction. Thus, steam that flows through the condenser side in the exhaust chamber 20 has a higher tendency to cause separation from the inner peripheral surface 51 of the flow guide 5 than steam that flows through the opposite condenser side. In this case, by forming the plurality of bypass flow passages 9 on the condenser side where separation of steam is likely to occur, it is possible to suppress separation of steam from the inner peripheral surface 51 of the flow guide 5 at the condenser side. Furthermore, by not forming the plurality of bypass flow passages 9 at the opposite condenser side, it is possible to prevent energy loss that is generated when steam flowing through the opposite condenser side mixes with steam flowing from the bypass flow passages 9. Thus, with the above configuration, it is possible to reduce fluid loss in the exhaust chamber 20 effectively.

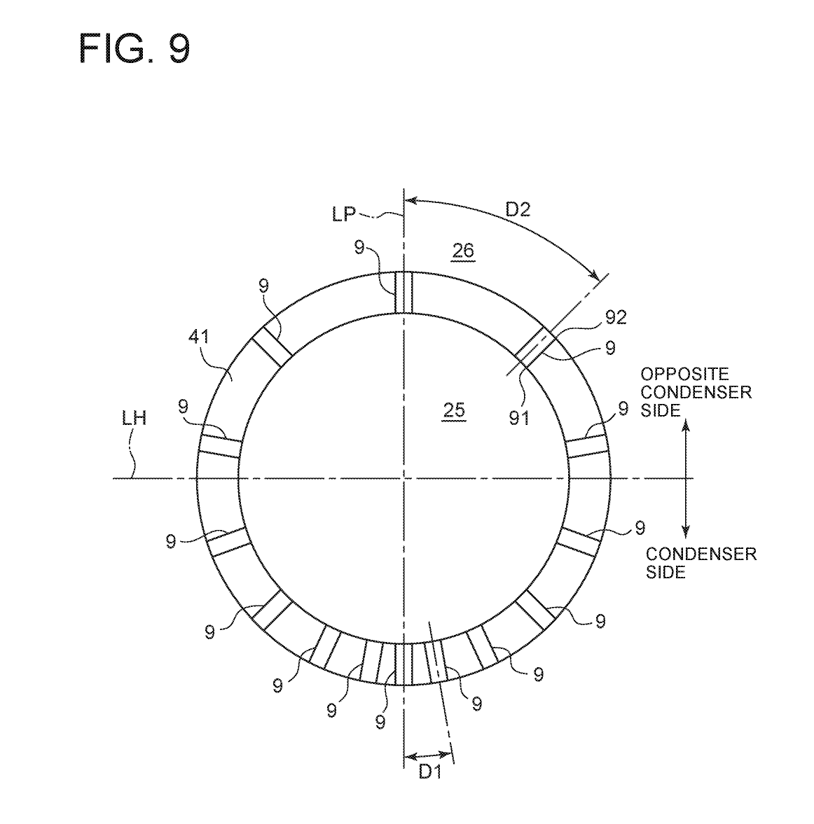

FIG. 9 is a schematic diagram for describing the bypass flow passage according to another embodiment of the present invention, disposed so as to have smaller intervals among one another in the circumferential direction at the condenser side than at the opposite condenser side, taken along a direction orthogonal to the axial direction of the steam turbine. In some embodiments, as depicted in FIG. 9, the above described bypass flow passage 9 includes a plurality of bypass flow passages 9 disposed with intervals between one another in the circumferential direction. Further, as depicted in FIG. 9, when the above described exhaust chamber 20 is divided into the condenser side where the condenser 16 is disposed and the opposite condenser side opposite to the side where the condenser 16 is disposed in the circumferential direction, the above described bypass flow passages 9 formed on the condenser side have smaller intervals between one another than the plurality of bypass flow passages 9 formed on the opposite condenser side.

Further, in the embodiment depicted in FIG. 9, when the line orthogonal to the horizontal line LH is a perpendicular line LP, the distance D1 between the bypass flow passage 9 whose axis is the perpendicular line LP and its adjacent bypass flow passage 9, among the plurality of bypass flow passages 9 formed on the condenser side, is smaller than the distance D2 between the bypass flow passage 9 whose axis is the perpendicular line LP and its adjacent bypass flow passage 9, among the plurality of bypass flow passages 9 formed on the opposite condenser side. Furthermore, the bypass flow passage 9 are formed such that the intervals between the bypass flow passages 9 gradually increase toward the perpendicular line LP on the opposite condenser side in the circumferential direction, starting from the perpendicular line LP on the condenser side.

As described above, steam that flows through the condenser side in the exhaust chamber 20 has a higher tendency to cause separation from the inner peripheral surface 51 of the flow guide 5 than steam that flows the opposite condenser side. With the above configuration, the intervals between the plurality of bypass flow passages 9 formed on the condenser side where separation of steam is more likely to occur are smaller than the intervals between the plurality of bypass flow passages 9 formed on the opposite condenser side, and thereby it is possible to suppress separation of steam from the inner peripheral surface 51 of the flow guide effectively at the condenser side. Furthermore, with the intervals between the plurality of bypass flow passages 9 formed on the opposite condenser side where separation of steam is less likely to occur being greater than the intervals between the plurality of bypass flow passages 9 formed on the condenser side, it is possible to suppress separation of steam from the inner peripheral surface 51 of the flow guide effectively at the opposite condenser side, while suppressing energy loss that is generated when steam flowing through the opposite condenser side mixes with steam flowing from the bypass flow passages 9.

Specifically, by forming the intervals among the bypass flow passages 9 to widen gradually toward the perpendicular line LP on the opposite condenser side in the circumferential direction starting from the perpendicular line LP on the condenser side, it is possible to suppress separation of steam from the inner peripheral surface 51 of the flow guide effectively at the condenser side, while suppressing energy loss that is generated when steam flowing through the opposite condenser side mixes with steam flowing from the bypass flow passages 9.

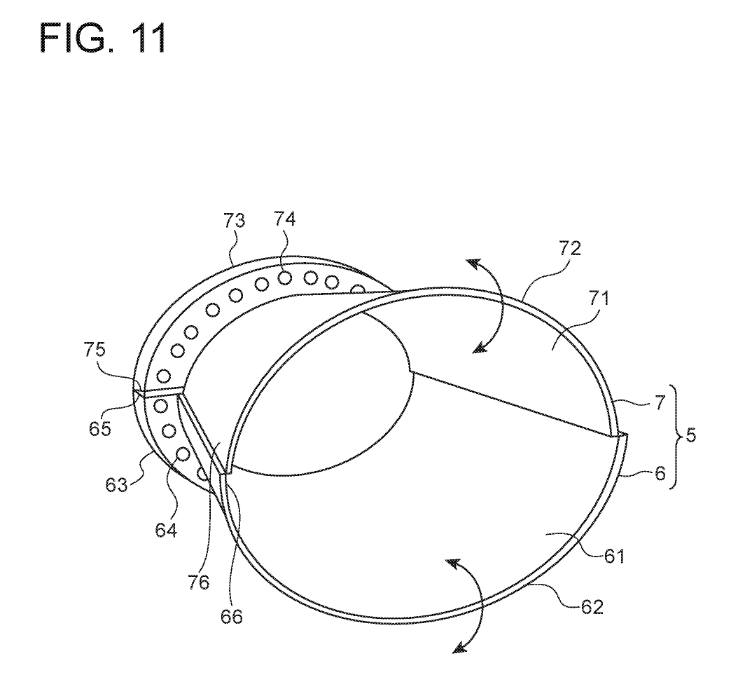

Next, with reference to FIGS. 10 to 12, the configuration of the flow guide 5 according to some embodiments will be described. FIG. 10 is a partial enlarged cross-sectional view, taken along the axial direction of a steam turbine apparatus, for describing the first flow guide and the second flow guide according to an embodiment of the present invention. FIG. 11 is a perspective view of the first flow guide and the second flow guide depicted in FIG. 10. Furthermore, the invention related to the flow guide 5 described can be implemented combined with some embodiments of the invention described above, or by itself

In some embodiments, as depicted in FIGS. 10 and 11, the above described flow guide 5 having a tubular shape includes the first flow guide 6 having an arch shape and the first concave-shaped surface 61 and the second flow guide 7 having an arch shape and the second concave-shaped surface 71 facing the first concave-shaped surface 61. Further, at least one of the first flow guide 6 or the second flow guide 7 is supported on the radially inner wall portion 41 so as to enable adjustment of the angle with respect to the axis of the steam turbine 1.

As depicted in FIGS. 10 and 11, the first flow guide 6 includes the first guide portion 62 having the first concave-shaped surface 61 and the first fastening portion 63 connected to an end portion at the upstream side of the first guide portion 62 so as to be inclined from the first guide portion 62. As depicted in FIGS. 10 and 11, the second flow guide 7 includes the second guide portion 72 having the second concave-shaped surface 71 and the second fastening portion 73 connected to an end portion at the upstream side of the second guide portion 72 so as to be inclined from the second guide portion 72. The second guide portion 72 of the second flow guide 7 has a smaller outer shape dimension than the first guide portion 62 of the first flow guide 6.

The first flow guide 6 is fastened to the end portion 43 at the downstream side of the radially inner wall portion 41 with bolts 18 inserted through bolt insertion holes 64 formed on the first fastening portion 63, in a state where the first elastic member 19A is nipped between the first fastening portion 63 and the end portion 43 at the downstream side of the radially inner wall portion 41. The bolt insertion holes 64 are formed on positions eccentrically displaced from the axis of the first fastening portion 63 in the radial direction. Thus, by adjusting the difference between intervals on the outer side and the inner side with respect to the radial direction between the first fastening portion 63 and the end portion 43 with the fastening force of the bolts 18, it is possible to adjust the angle of the first guide portion 62 with respect to the axis of the steam turbine 1.

The second flow guide 7 is fastened to the end portion 43 at the downstream side of the radially inner wall portion 41 with bolts 18 inserted through bolt insertion holes 74 formed on the second fastening portion 73, in a state where the second elastic member 19B is nipped between the second fastening portion 73 and the end portion 43 at the downstream side of the radially inner wall portion 41. The bolt insertion holes 74 are formed on positions eccentrically displaced from the axis of the second fastening portion 73 in the radial direction. Thus, by adjusting the difference between intervals on the outer side and the inner side with respect to the radial direction between the second fastening portion 73 and the end portion 43 with the fastening force of the bolts 18, it is possible to adjust the angle of the second guide portion 72 with respect to the axis of the steam turbine 1.

A tapered surface 65 whose thickness decreases toward the first guide portion 62 is formed on an arc end of each of the opposite sides of the first fastening portion 63. Furthermore, a tapered surface 75 whose thickness decreases toward the second guide portion 72 is formed on an arc end of each of the opposite sides of the second fastening portion 73. Thus, it is possible to prevent interference between the first fastening portion 63 and the second fastening portion 73, when adjusting the angle of at least one of the first flow guide 6 or the second flow guide 7 so as to reduce the opening formed by the first guide portion 62 and the second guide portion 72.

Furthermore, the outer shape dimension of the inner peripheral surface 66 of the first guide portion 62 is the same as or slightly greater than the outer shape dimension of the outer peripheral surface 76 of the second guide portion 72. Thus, it is possible to accommodate the arc ends of both sides of the second guide portion 72 inside the arc ends of both sides of the first guide portion 62, by locating the inner peripheral surface 66 of the first guide portion 62 to face the outer peripheral surface 76 of the second guide portion 72. In this case, it is possible to expand the range of angle that is adjustable for the first guide portion 62 and the second guide portion 72. Further, by reducing the gap formed between the inner peripheral surface 66 of the first guide portion 62 and the outer peripheral surface 76 of the second guide portion 72, it is possible to reduce pressure loss of steam due to the flow guide 5.

Herein, the efficiency of the steam turbine 1 may deteriorate due to environmental change. More specifically, the pressure inside the condenser 16 changes due to environmental change such as seasonal temperature change. The change of the pressure inside the condenser 16 brings about change in the flow of steam in the exhaust chamber 20. In a case where the temperature is particularly high, the pressure inside the condenser 16 increases (becomes low vacuum), and thus turbulence occurs in the flow of steam flowing inside the exhaust chamber 20. If such a turbulence occurs in the flow of steam flowing through the exhaust chamber 20, the fluid loss in the exhaust chamber 20 increases, and the efficiency of the steam turbine 1 may deteriorate.

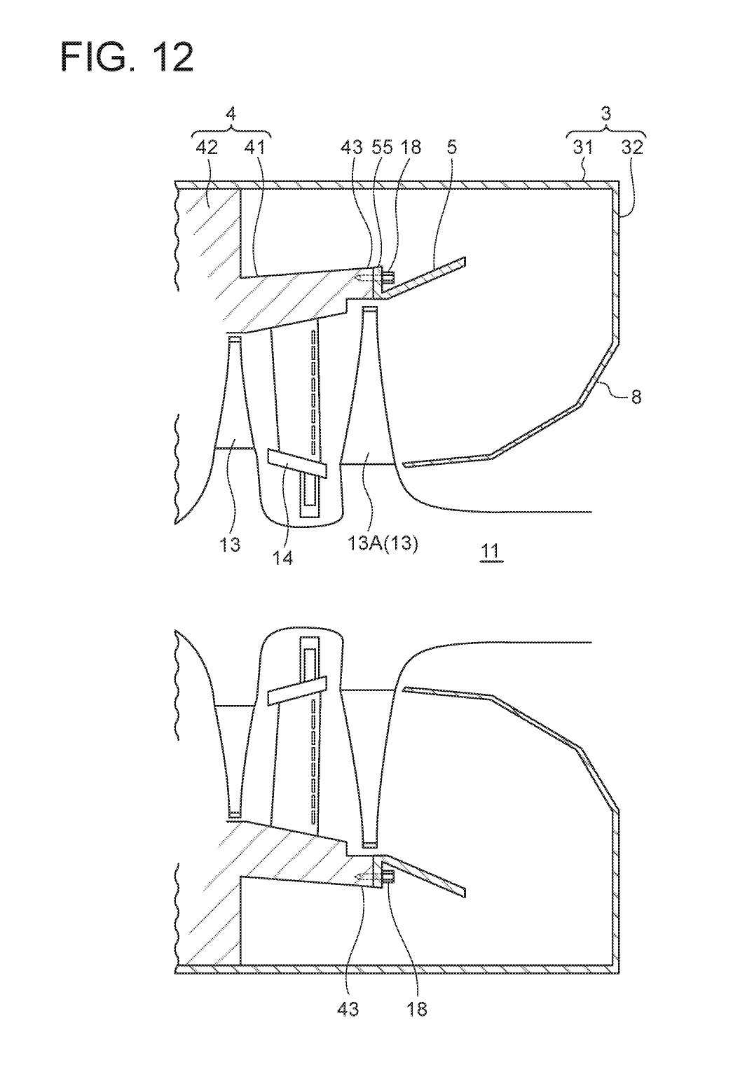

FIG. 12 is a partial enlarged cross-sectional view, taken along the axial direction of the steam turbine apparatus, for describing the flow guide according to a comparative example. In FIG. 12, members having the same reference numerals as those in the embodiment depicted in FIGS. 10 and 11 are not described again. The flow guide 5 in the comparative example depicted in FIG. 12 is formed by a single tubular member. The flow guide 5 is fastened to the end portion 43 at the downstream side of the radially inner wall portion 41 with bolts 18 inserted through bolt insertion holes formed on the fastening portion 55, in a state where the fastening portion 55 is in contact with the end portion 43. In this case, like the configurations disclosed in Patent Documents 1 and 2, it is difficult to suppress deterioration of the efficiency of the steam turbine 1 due to environmental change.

In contrast, with the above configuration, the flow guide 5 having a tubular shape includes the first flow guide 6 having an arch shape and the second flow guide 7 having an arch shape. Further, at least one of the first flow guide 6 or the second flow guide 7 is supported on the radially inner wall portion 41 so as to enable adjustment of the angle with respect to the axis of the steam turbine 1. Thus, it is possible to improve the efficiency of the steam turbine 1 by adjusting the angles of the first flow guide 6 and the second flow guide 7 in response to the above described environmental change.

In some embodiments, the first flow guide 6 described above includes the first fastening portion 63 fastened to the end portion 43 at the downstream side of the radially inner wall portion 41 by bolt fastening. Further, the second flow guide 7 described above includes the second fastening portion 73 fastened to the end portion 43 at the downstream side of the radially inner wall portion 41 by bolt fastening. Further, the steam turbine apparatus 2 described above further includes a first elastic member 19A nipped between the end portion 43 at the downstream side of the radially inner wall portion 41 described above and the first fastening portion 63 described above, and a second elastic member 19B nipped between the end portion 43 at the downstream side of the radially inner wall portion 41 described above and the second fastening portion 73 described above.

With the above configuration, the first flow guide 6 and the second flow guide 7 are biased by elastic forces of the first elastic member 19A and the second elastic member 19B, and thus it is possible to prevent loosening of the flow guides. Specifically, in a case where the first fastening portion 63 and the second fastening portion 73 are bended with respect to guide surfaces of the first flow guide 6 and the second flow guide 7 (the first concave-shaped surface 61, the second concave-shaped surface 71) for guiding steam, and the bolts 18 for bolt fastening are inserted through at positions eccentrically displaced in the radial direction from the axes of the first fastening portion 63 and the second fastening portion 73, it is possible to adjust the angles of the first flow guide 6 and the second flow guide 7 easily by adjusting the fastening force of bolt fastening. Thus, it is possible to adjust the angles of the first flow guide 6 and the second flow guide 7 in a short period of time, and thus it is possible to reduce the time required to start the steam turbine 1.

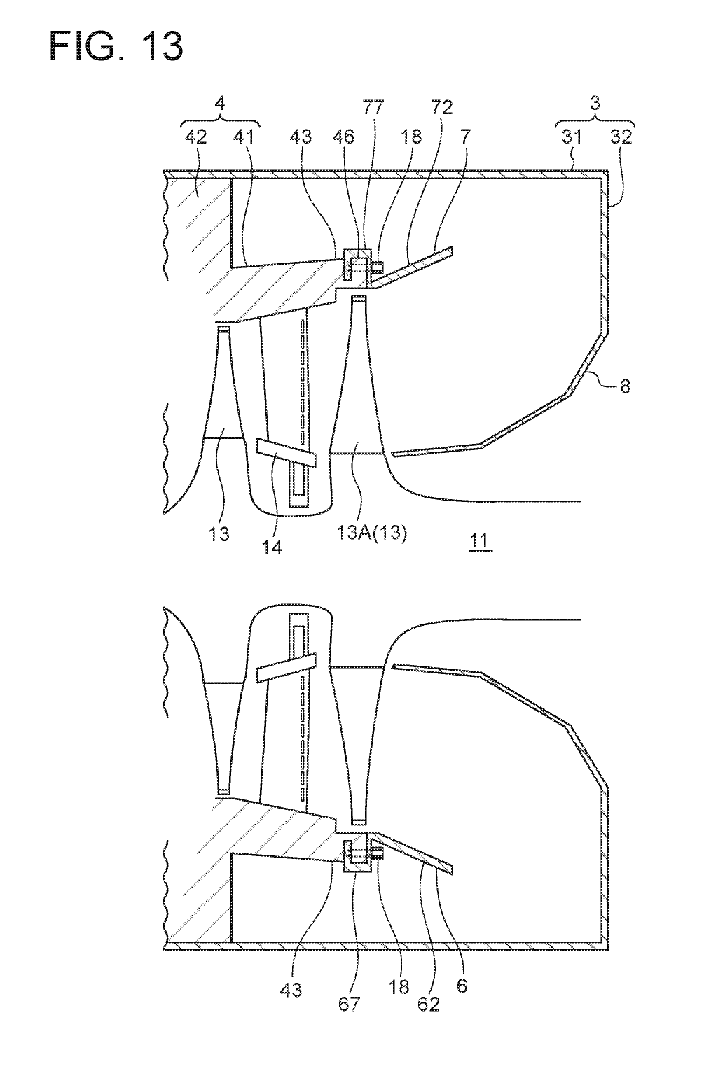

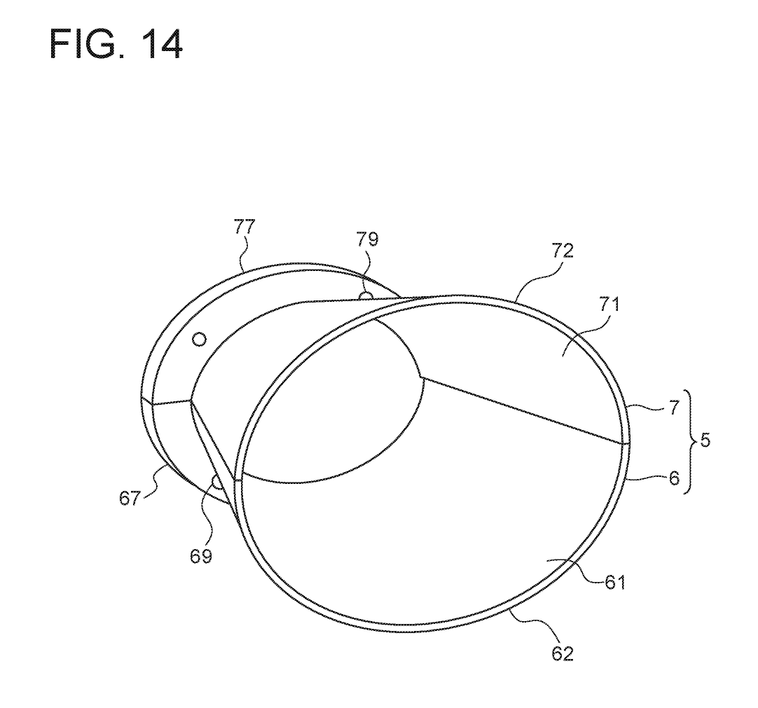

Next, with reference to FIGS. 13 and 14, the configuration of the flow guide 5 according to another embodiment will be described. FIG. 13 is a partial enlarged cross-sectional view, taken along the axial direction of a steam turbine apparatus, for describing the first flow guide and the second flow guide according to an embodiment of the present invention. FIG. 14 is a perspective view of the first flow guide and the second flow guide depicted in FIG. 13. Furthermore, the invention related to the flow guide 5 described below can be implemented combined with some embodiments of the invention described above, or by itself.

In some embodiments, as depicted in FIGS. 13 and 14, the above described flow guide 5 having a tubular shape includes the first flow guide 6 having an arch shape and the first concave-shaped surface 61 and the second flow guide 7 having an arch shape and the second concave-shaped surface 71 facing the first concave-shaped surface 61. Further, the radially inner wall portion 41 has a protruding portion 46 (engageable portion) on the end portion 43 at the downstream side. Furthermore, the first flow guide 6 includes a first engaging recess portion 67 (first engaging portion) that is engageable with the protruding portion 46, and the second flow guide 7 includes a second engaging recess portion 77 (second engaging portion) that is engageable with the protruding portion 46.

As depicted in FIGS. 13 and 14, the first flow guide 6 includes the first guide portion 62 having the first concave-shaped surface 61 and the first engaging recess portion 67 connected to an end portion at the upstream side of the first guide portion 62 so as to be inclined from the first guide portion 62. As depicted in FIGS. 13 and 14, the second flow guide 7 includes the second guide portion 72 having the second concave-shaped surface 71 and the second engaging recess portion 77 connected to an end portion at the upstream side of the second guide portion 72 so as to be inclined from the second guide portion 72. The second guide portion 72 of the second flow guide 7 has an outer shape dimension of the same size as the first guide portion 62 of the first flow guide 6.

In the embodiment depicted in FIG. 13, the protruding portion 46 has a shape protruding in an annular shape toward the outer side, with respect to the radial direction, of the outer peripheral surface of the end portion 43 at the downstream side of the radially inner wall portion 41. The first engaging recess portion 67 includes a groove having an arc shape formed thereon. The groove has a U-shaped cross section along the axial direction. Further, the second engaging recess portion 77 includes a groove having an arc shape formed thereon. The groove has a U-shaped cross section along the axial direction.

The first flow guide 6 is fastened to the end portion 43 at the downstream side of the radially inner wall portion 41 with bolts 18 inserted through bolt insertion holes 69 formed on the first engaging recess portion 67, in a state where the groove portion of the first engaging recess portion 67 is engaged with the protruding portion 46. Further, the second flow guide 7 is fastened to the end portion 43 at the downstream side of the radially inner wall portion 41 with bolts 18 inserted through bolt insertion holes 79 formed on the second engaging recess portion 77, in a state where the groove portion of the second engaging recess portion 77 is engaged with the protruding portion 46.

Further, in some other embodiments, instead of the protruding portion 46 having an annular shape, the end portion 43 may include a protruding portion 46 having an arc shape or a recess portion having an arc shape as the engageable portion. It is sufficient if the first engaging portion of the first flow guide 6 and the second engaging portion of the second flow guide are configured to be engageable with the engageable portion, and the end portion 43 may include an arc-shaped protruding portion that protrudes toward the outer side or the inner side in the radial direction.

With the above configuration, the flow guide 5 having a tubular shape includes the first flow guide 6 having an arch shape and the second flow guide 7 having an arch shape. Further, since the first flow guide 6 and the second flow guide 7 include the first engaging recess portion 67 (first engaging portion) and the second engaging recess portion 77 (second engaging portion) that are engageable with the protruding portion 46 (engageable portion) of the radially inner wall portion 41, the first flow guide 6 and the second flow guide 7 can be attached to and removed from the radially inner wall portion 41 more easily than a flow guide 5 formed to have a tubular shape, which makes it possible to perform replacement in a shorter period of time. Thus, it is possible to reduce the time required to start operation of the steam turbine 1. Further, while the efficiency of the steam turbine 1 may deteriorate due to environmental change as described above, it is possible to improve the efficiency of the steam turbine 1 by replacing the flow guide 5 with one that is more suitable to the environment.

In some embodiments, as depicted in FIG. 13, the above described first flow guide 6 is configured to be fastenable by bolt fastening in a state where the first engaging recess portion 67 (first engaging portion) is engaged with the protruding portion 46 (engageable portion). Furthermore, the above described second flow guide 7 is configured to be fastenable by bolt fastening in a state where the second engaging recess portion 77 (second engaging portion) is engaged with the protruding portion 46 (engageable portion).

With the above configuration, the first flow guide 6 and the second flow guide 7 are structured so as not to be easily detached from the radially inner wall portion 41, as the first engaging recess portion 67 (first engaging portion) and the second engaging recess portion 77 (second engaging portion) are engaged with the protruding portion 46 (engageable portion). Thus, it is possible to reduce the number of bolts 18 required for bolt fastening, compared to a structure where the first and second engaging portions are not engaged with the engageable portion. Furthermore, as a smaller number of bolts 18 are required for bolt fastening, the first flow guide 6 and the second flow guide 7 can be attached to and removed from the radially inner wall portion 41 even more easily, which makes it possible to perform replacement in an even shorter period of time, and it is possible to reduce the time required to start operation of the steam turbine 1 even further.

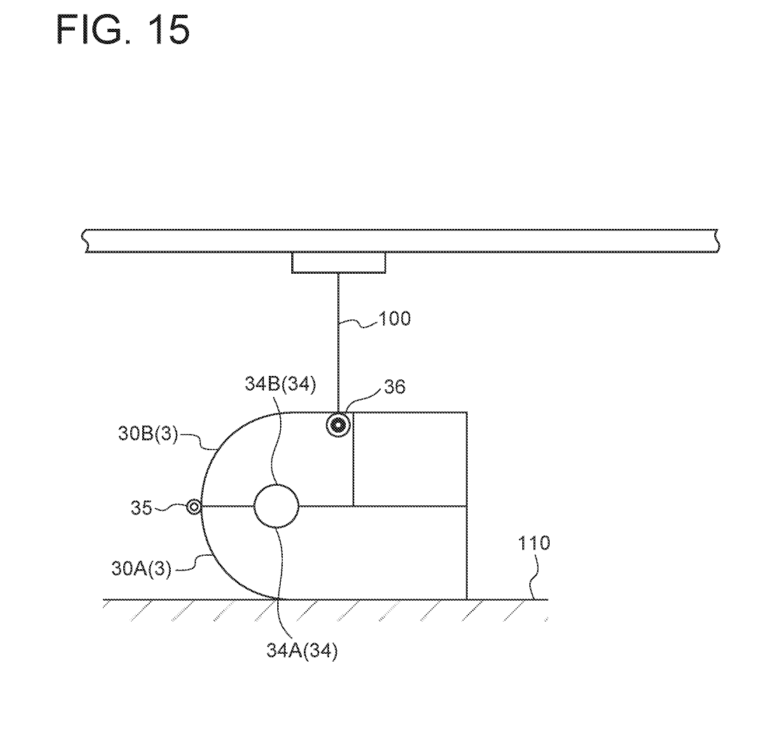

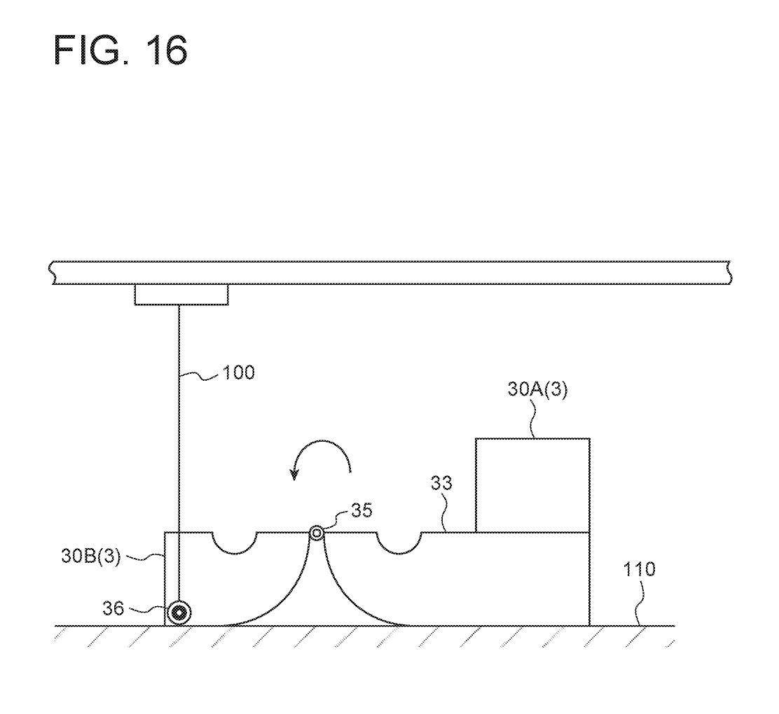

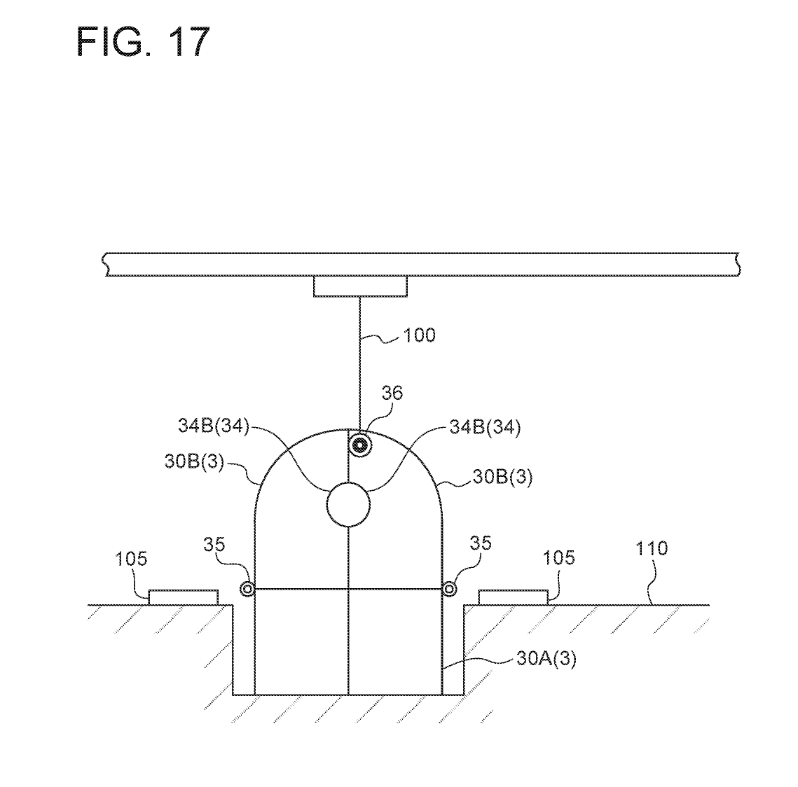

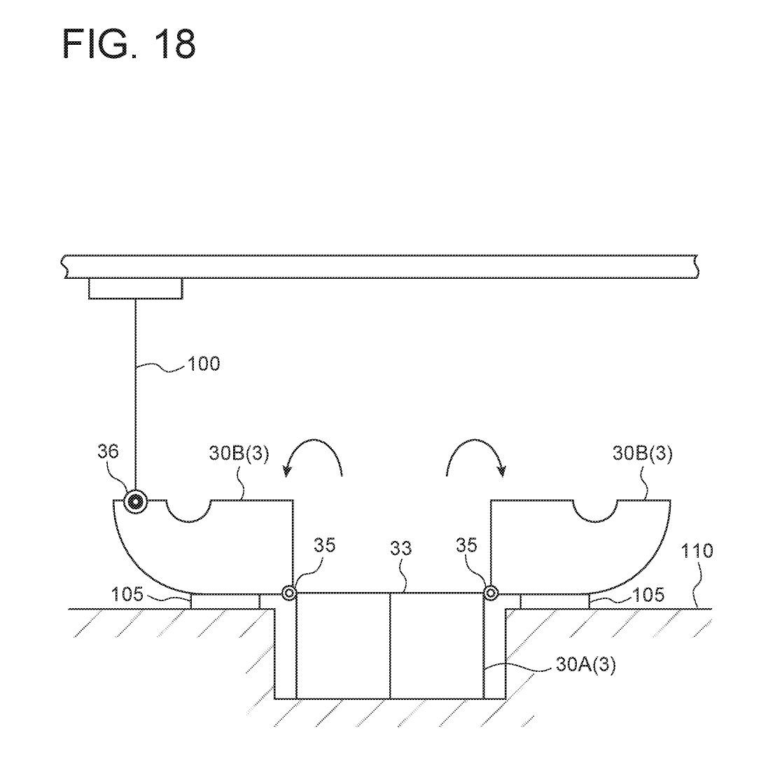

Next, with reference to FIGS. 15 to 19, the configuration of the outer casing 3 according to some embodiments will be described. FIG. 15 is a schematic diagram for describing an outer casing and a crane that suspends the outer casing according to an embodiment of the present invention, showing a state where the first outer casing is closed with the second outer casing along a direction orthogonal to the axial direction of the steam turbine. FIG. 16 is a schematic diagram showing a state where the second outer casing depicted in FIG. 15 is opened 180 degrees relative to the first outer casing, along a direction orthogonal to the axial direction of the steam turbine. FIG. 17 is a schematic diagram for describing outer casings and a crane that suspends the outer casings according to another embodiment of the present invention, showing a state where the first outer casing is closed with the second outer casings along a direction orthogonal to the axial direction of the steam turbine. FIG. 18 is a schematic diagram showing a state where the two second outer casings in FIG. 17, disposed on both of the right and left sides of the drawing, are opened 90 degrees relative to the first outer casing, along a direction orthogonal to the axial direction of the steam turbine. Furthermore, the invention related to the outer casing 3 described below can be implemented combined with some embodiments of the invention described above, or by itself.

As depicted in FIGS. 15 to 18, in some embodiments, the above described outer casing 3 includes a first outer casing 30A having an opening portion 33 and a second outer casing 30B that is capable of closing the opening portion 33 of the first outer casing 30A. The second outer casing 30B is connected to the outer casing 30A rotatably via a hinge 35.

In the embodiment depicted in FIGS. 15 and 16, the first outer casing 30A is disposed laterally on the contact surface 110, that is, so as to extend along the horizontal direction. As depicted in FIG. 15, the first outer casing 30A has a first cutout 34A having an arc shape on which a through hole 34 for inserting the rotor 11 is formed so as to face the second cutout 34B having an arc shape formed on the second outer casing 30B when closed by the second outer casing 30B. As depicted in FIGS. 15 and 16, the hinge 35 connects the first outer casing 30A and the second outer casing 30B at an end portion on the opposite condenser side. The second outer casing 30B has a hook attachment portion 36 on a position closer to an end portion opposite to the end portion with the hinge 35 with respect to the horizontal direction. With a crane 100 attached to the hook attachment portion 36, the second outer casing 30B rotates relative to the first outer casing 30A about the hinge 35.

In the embodiment depicted in FIGS. 17 and 18, the above described outer casing 3 includes a single first outer casing 30A and two second outer casings 30B. Furthermore, the first outer casing 30A is disposed upright on the contact surface 110, that is, so as to extend along the vertical direction. As depicted in FIG. 17, the two second outer casings 30B have insertion holes 34 for inserting the rotor 11 formed thereon, as the second cutouts 34B having an arc shape formed on the respective second outer casings 30B face one another when the second outer casings 30B close the first outer casing 30A. As depicted in FIGS. 17 and 18, the hinge 35 connects the upper end portion of the outer periphery of the first outer casing 30A and the lower end portions of the outer peripheries of the second outer casings 30B. The second outer casings 30B have a hook attachment portion 36 on a position closer to the upper end portion. With a crane 100 attached to the hook attachment portion 36, the second outer casing 30B rotates relative to the first outer casing 30A about the hinge 35. Furthermore, as depicted in FIGS. 17 and 18, to prevent the second outer casings 30B from making contact with the hard contact surface 110 such as concrete and getting damaged when being rotated, a soft plate-shaped member 105 made of wood, for instance, may be disposed on the contact surface 110.

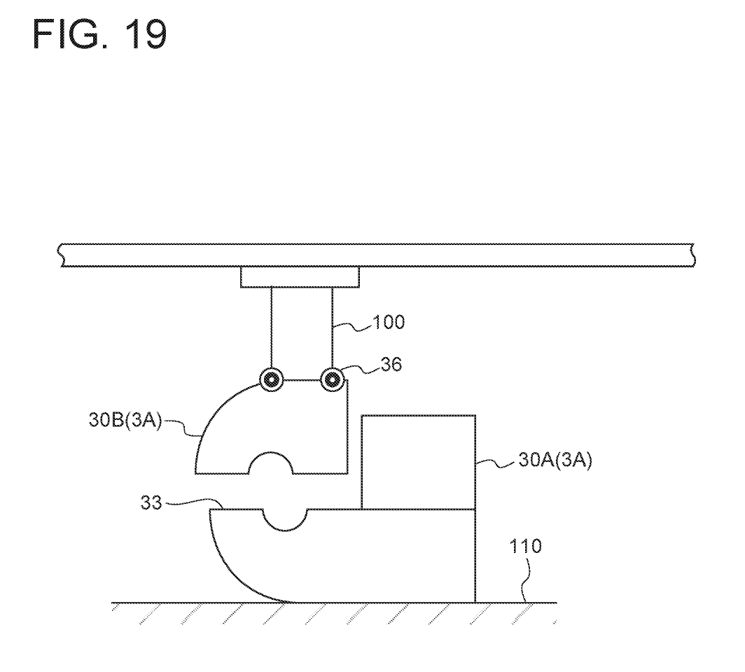

FIG. 19 is a schematic diagram for describing an outer casing and a crane that suspends the outer casing according to a comparative example, along a direction orthogonal to the axial direction of the steam turbine. As depicted in FIG. 19, the outer casing 3A according to a comparative example includes a first outer casing 30A having an opening portion 33 and a second outer casing 30B that is capable of closing the first outer casing 30A and that is completely separable from the first outer casing 30A. The second outer casing 30B can be transferred to a position to close the first outer casing 30A, or a position away from the first outer casing 30A by being suspended on the crane 100.

In a case where the second outer casing 30B and the first outer casing 30A are completely separable as depicted in FIG. 19, it is necessary to determine the position when attaching the second outer casing 30B to the first outer casing 30A, which may take some time. With the above configuration depicted in FIGS. 17 and 18, the second outer casing 30B is capable of closing the opening portion 33 of the first outer casing 30A thanks to the hinge 35, and is also connected to the first outer casing 30A rotatably via the hinge 35. Accordingly, it is possible to rotate and open the second outer casing 30B relative to the first outer casing 30A. Furthermore, since the second outer casing 30B is connected to the first outer casing 30A via the hinge 35, it is possible to cut or simplify the position determining work when closing the opening portion 33 of the first outer casing 30A. Thus, it is possible to reduce the time required to open and close the second outer casing 30B, and thus it is possible to improve the maintenance performance such as replacement of the diffuser (flow guide 5 or bearing cone 8). Further, while the efficiency of the steam turbine 1 may deteriorate due to environmental change as described above, it is possible to improve the efficiency of the steam turbine 1 by replacing the diffuser with one that is more suitable to the environment.

Embodiments of the present invention were described in detail above, but the present invention is not limited thereto, and various amendments and modifications may be implemented.

1. A steam turbine apparatus, comprising:
an exhaust chamber which defines an exhaust flow passage inside, for guiding steam after passing through a last stage rotor blade of a steam turbine to a condenser;
an outside casing including a radially outer wall portion formed on a radially outer side of the exhaust flow passage;
an inside casing including a radially inner wall portion disposed on an inner side of the radially outer wall portion with respect to a radial direction;
a flow guide disposed on an end portion at a downstream side of the radially inner wall portion with respect to a flow direction, the flow guide having a tubular shape whose distance from an axial center of the steam turbine increases along the flow direction towards downstream; and
at least one bypass flow passage connecting a first inner space upstream of the last stage rotor blade and a second inner space positioned at an outer side of the flow guide with respect to the radial direction in the exhaust flow passage, the at least one bypass flow passage extending along an outer peripheral surface of the flow guide.

2. The steam turbine apparatus according to claim 1,
wherein the bypass flow passage comprises a through hole formed through the radially inner wall portion.

3. The steam turbine apparatus according to claim 1,
wherein the bypass flow passage is at least partially formed inside the flow guide.

4. The steam turbine apparatus according to claim 3,
wherein the bypass flow passage has an outlet-side opening which is in communication with the second inner space and which is formed on an end surface at a downstream side of the flow guide with respect to the flow direction.

5. The steam turbine apparatus according to claim 1,
wherein the bypass flow passage has an outlet-side opening which is in communication with the second inner space, the outlet-side opening having an axis which is inclined from the radial direction downstream with respect to the flow direction in a circumferential direction, in an axial-directional view of the steam turbine.

6. The steam turbine apparatus according to claim 1,
wherein the at least one bypass flow passage includes a plurality of bypass flow passages disposed at intervals from one another in a circumferential direction, and
wherein, when the exhaust chamber is divided into, with respect to the circumferential direction, a condenser side where the condenser is provided and an opposite condenser side opposite to the condenser side, the plurality of bypass flow passages are formed only on the condenser side.

7. The steam turbine apparatus according to claim 1,
wherein the at least one bypass flow passage includes a plurality of bypass flow passages disposed at intervals from one another in a circumferential direction, and
wherein, when the exhaust chamber is divided into, with respect to the circumferential direction, a condenser side where the condenser is provided and an opposite condenser side opposite to the condenser side, the plurality of bypass flow passages formed on the condenser side have smaller intervals between one another than the plurality of bypass flow passages formed on the opposite condenser side.

8. The steam turbine apparatus according to claim 1,
wherein the flow guide having a tubular shape includes:
a first flow guide having an arch shape and a first concave-shaped surface; and
a second flow guide having an arch shape and a second concave-shaped surface which faces the first concave-shaped surface, and
wherein at least one of the first flow guide or the second flow guide is supported on the radially inner wall portion so as to enable adjustment of an angle with respect to an axis of the steam turbine.

9. The steam turbine apparatus according to claim 8,
wherein the first flow guide includes a first fastening portion fastened to an end portion at the downstream side of the radially inner wall portion by bolt fastening,
wherein the second flow guide includes a second fastening portion fastened to the end portion at the downstream side of the radially inner wall portion by bolt fastening, and
wherein the steam turbine apparatus further includes a first elastic member nipped between the end portion at the downstream side of the radially inner wall portion and the first fastening portion and a second elastic member nipped between the end portion at the downstream side of the radially inner wall portion and the second fastening portion.

10. The steam turbine apparatus according to claim 1,
wherein the flow guide having a tubular shape includes:
a first flow guide having an arch shape and a first concave-shaped surface; and
a second flow guide having an arch shape and a second concave-shaped surface which faces the first concave-shaped surface, and
wherein the radially inner wall portion includes an engageable portion on the end portion at the downstream side of the radially inner wall portion,
wherein the first flow guide includes a first engaging portion which is engageable with the engageable portion, and
wherein the second flow guide includes a second engaging portion which is engageable with the engageable portion.

11. The steam turbine apparatus according to claim 10,
wherein the first flow guide is configured to be capable of being fastened by bolt fastening in a state where the engageable portion is engaged with the first engaging portion, and
wherein the second flow guide is configured to be capable of being fastened by bolt fastening in a state where the engageable portion is engaged with the second engaging portion.

12. The steam turbine apparatus according to claim 1,
wherein the outer casing includes a first outer casing having an opening portion and a second outer casing capable of closing the opening portion of the first outer casing, the second outer casing being connected rotatably to the first outer casing via a hinge.
